(19) United States
(12) Patent Application Publication
(10) Pub. No.: US 2025/0065324 A1
(43) Pub. Date: Feb. 27, 2025

(54) FLUIDIC TRANSISTORS AND USES THEREOF

(71) Applicant: The General Hospital Corporation, Boston, MA (US)

(72) Inventors: Kaustav Aras Gopinathan, Brookline, MA (US); Mehmet Toner, Charlestown, MA (US)

(21) Appl. No.: 18/287,948

(22) PCT Filed: Apr. 22, 2022
(86) PCT No.: PCT/US2022/071859

§ 371 Date: Oct. 23, 2023

Related U.S. Application Data
(60) Provisional application No. 63/178,672, filed on Apr. 23, 2021.

(51) Int. Cl. B01L 3/00

(52) U.S. Cl. CPC B01L 3/502715; B01L 3/502707; B01L 3/502753; B01L 2200/0668; B01L 2300/0816; B01L 2300/087; B01L 2300/123; B01L 2300/14; B01L 2400/0487; B01L 2400/082

(57) ABSTRACT

A fluidic transistor comprising: a flow region configured to transport a first fluid; a gate region configured to contain a second fluid; and a deformable region disposed between the flow and gate regions, wherein the deformable region is configured to induce flow-limitation as the first fluid is transported within the flow region.

### CROSS-REFERENCE TO RELATED APPLICATION

This application claims the benefit of U.S. Provisional Patent Application No. 63/178,672, filed on Apr. 23, 2021, which is incorporated by reference herein in its entirety.

### STATEMENT OF GOVERNMENT INTEREST

This invention was made with Government support under Contract Nos. 1R21CA260989-01A1, 1R01CA255602-01, and 5U01CA214297-04 awarded by the National Institutes of Health and under Contract no. T32GM007753 awarded by the National Institute of General Medical Sciences. The Government has certain rights in the invention.

### FIELD

The present disclosure relates to a fluidic transistor. Also disclosed are various uses including one or more fluidic transistors, such as in fluidic networks. Methods of making and using such fluidic transistors are also described.

### BACKGROUND

Various components can be used to control the flow of fluid, as well as reagents or substances contained within that fluid. In particular, the field of microfluidics uses channels, chambers, valves, and the like to control such flow using small volumes of fluid.

### SUMMARY

The present disclosure relates to a fluidic transistor. In particular non-limiting embodiments, the fluidic transistor possesses characteristics that are observed in an electronic transistor, such as signal amplification. Whereas an electronic transistor employs an electronic signal, the fluidic transistor herein employs a fluidic signal. In this way, the fluidic transistor can be used to manipulate fluid flow, such that an input fluidic signal (e.g., an input pressure signal, an input flow signal, and the like) can be amplified to provide a desired output fluidic signal (e.g., an output pressure signal, an output flow signal, and the like).

In some embodiments, the fluidic transistor can be characterized as a three-terminal device, which has a source, a drain, and a gate. Various signals (e.g., one or more input, gating, and/or an output fluidic signals) can be provided to each terminal to realize a desired topology and/or perform a signal processing operation.

Structurally, the fluidic transistor includes a deformable region, which is configured to induce or exploit the fluidic phenomenon of flow-limitation, as described herein. In brief, flow-limitation is a phenomenon observed with confined flows through regions having deformable boundaries, such that non-linear fluidic characteristics are observed under certain threshold conditions. In some embodiments, conditions that provide such flow-limitation can be characterized by a Shapiro number (S) that is greater than one. In other embodiments, the fluidic transistor can possess a characteristic dimension (e.g., characteristic width, length, height, cross-sectional area, etc.) and/or be operated under certain conditions (e.g., density or flow rate of the fluid flowing through the fluidic transistor) and/or include certain properties of the deformable region (e.g., flexural rigidity, Poisson's ratio, Young's modulus etc.) to provide S≥1.

Accordingly, in one embodiment, the present disclosure encompasses a fluidic transistor including: a flow region configured to transport a first fluid; a gate region configured to contain a second fluid; and a deformable region disposed between the flow and gate regions. In some embodiments, the deformable region is configured to induce flow-limitation as the first fluid is transported within the flow region. In other embodiments, a deformation of the deformable region induces the flow-limitation of the first fluid in the flow region. In yet other embodiments, the deformable region is configured to provide the first fluid at a velocity that is at or faster than a characteristic propagation velocity for the flow region.

In some embodiments, the flow region is disposed above or below the gate region, or the flow region is disposed beside the gate region. In other embodiments, the flow region includes a characteristic dimension from about 10 nm to about 1 mm and/or a cross-sectional area of about 100 nm² to about 1 mm².

In some embodiments, the fluidic transistor further includes; a flow channel including an inlet serving as a source and an outlet serving as a drain, wherein the flow region is disposed within the flow channel and wherein the flow channel is configured to transport the first fluid from the source to the drain.

In other embodiments, the fluidic transistor further includes: a gate channel including an inlet and an outlet, wherein the gate region is disposed within the gate channel and wherein the gate channel is configured to confine the second fluid between the inlet and the outlet of the gate channel.

In some embodiments, the flow channel is substantially perpendicular or substantially parallel to the gate channel. In particular embodiments, a cross-section of the flow channel and/or a cross-section of the gate channel is substantially square, quadrilateral, circular, oval, semi-circular, or curvilinear. In other embodiments, a cross-section of the flow channel and/or a cross-section of the gate channel varies in the direction of flow to create a contracting taper, an expanding taper, or another geometrical volume.

In some embodiments, the flow and gate channels are disposed in a single substrate or in different substrates. In particular embodiments, the single substrate or the different substrates include glass, plastic, a semiconductor, a metal, an elastomer, or a combination thereof.

In some embodiments, the flow channel is configured to provide the first fluid at a flow rate of about 1 fL/s to about 1 mL/s.

In some embodiments, the deformable region is configured to minimize fluidic communication between the flow and gate channels. In other embodiments, the deformable region is configured to deflect upon applying pressure between the gate region and the source.

In some embodiments, the fluidic transistor includes: a deformable layer disposed between the flow channel and the gate channel, wherein the deformable region is disposed within the deformable layer.

In some embodiments, the fluidic transistor has a unity gain frequency of less than about 1 MHz. In other embodiments, the fluidic transistor is characterized by a Shapiro number S that is greater than or equal to 1. In yet other embodiments, the fluidic transistor is a microfluidic transistor.

In a second aspect, the present disclosure encompasses a fluidic network including one or more fluidic transistors (e.g., any described herein). In some embodiments, the fluidic transistor is configured in a common-source topology, a common-gate topology, or common-drain topology. In other embodiments, the fluidic transistor is configured in a combination of two or more topologies, wherein the topologies are selected from the group of a common-source topology, a common-gate topology, and a common-drain topology.

In some embodiments, the fluidic network is configured as a fluidic amplifier, a fluidic flow-buffer, a fluidic regulator, a fluidic pressure-buffer, a fluidic level-shifter, or a fluidic logic gate.

In some embodiments, the fluidic network includes a fluidic amplifier in the common-source topology. In particular embodiments, the fluidic amplifier includes: the fluidic transistor, wherein a gate region of the fluidic transistor is configured as an input terminal for an input pressure signal with respect to a source region, and wherein a drain region is configured as an output terminal to provide an amplified output signal with respect to the source region, as compared to the input pressure signal. In some embodiments, the amplified output signal is configured such that a change in the pressure of the input pressure signal is less than a change in the pressure of the amplified output signal.

In other embodiments, the fluidic network includes a fluidic flow-buffer in the common-gate topology. In particular embodiments, the fluidic flow-buffer includes: a fluidic transistor, wherein a source region of the fluidic transistor is configured as an input terminal for an input flow signal, and wherein a drain region is configured as an output terminal to provide an output fluidic signal including a flow rate that is substantially equal to that of the input flow signal and including a greater pressure, as compared to an input flow signal in direct fluidic communication with the output fluidic signal. In some embodiments, the fluidic network includes a fluidic regulator, wherein, a first terminal of a fluidic load is in fluidic communication with the source region; a second terminal of the fluidic load is in fluidic communication with a gate region, is configured as an input terminal and; and the drain region is configured as an output terminal such that a relative change in the pressure of an input pressure signal produces a smaller relative change in the flow of an output flow signal.

In some embodiments, the fluidic network includes a fluidic pressure-buffer in the common-drain topology. In particular embodiments, the fluidic pressure-buffer includes: a fluidic transistor, wherein a gate region of the fluidic transistor is configured as an input terminal for an input pressure signal; and wherein a source region is configured as an output terminal to provide an output fluidic signal including pressure that is substantially equal to that of the input pressure signal and including a greater flow rate, as compared to an input pressure signal in direct fluidic communication with the output fluidic signal.

In some embodiments, the fluidic network includes a fluidic level-shifter, wherein: a first terminal of a fluidic load is in fluidic communication with the source region, and a second terminal of the fluidic load is configured as an output terminal such that an output pressure signal is level-shifted, as compared to the input pressure signal. In particular embodiments, a static component of the input pressure signal is offset by a fixed amount.

In some embodiments, the fluidic network includes the fluidic logic gate. In particular embodiments, the fluidic logic gate includes: a plurality of fluidic transistors, wherein gate regions of the plurality of the fluidic transistors are configured as input terminals for a plurality of input fluidic signals; and wherein drain regions of the plurality of fluidic transistors are in fluidic connection and are configured as an output terminal to provide an output fluidic signal that varies in pressure depending on pressure of the plurality of input fluidic signals.

In other embodiments, the fluidic logic gate includes: a plurality of fluidic transistors, wherein gate regions of the plurality of the fluidic transistors are configured as input terminals for a plurality of input fluidic signals; wherein the plurality of fluidic transistors are connected via fluidic communication in a series order; wherein a drain region of a first fluidic transistors in the series order is in fluidic communication with a source region of a second fluidic transistor that is next in the series order; and wherein a drain region of a last fluidic transistor is configured as an output terminal to provide an output fluidic signal that varies in pressure depending on the pressures of the input fluidic signals.

In some embodiments, the fluidic network further includes a subcircuit, wherein the subcircuit includes the one or more fluidic transistors. In particular embodiments, the subcircuit includes a fluidic amplifier, a fluidic regulator, a fluidic level-shifter, and/or a fluidic logic gate. In other embodiments, the fluidic network further includes one or more of a fluidic load, a fluidic resistor, a fluidic capacitor, a fluidic inductor, a fluidic trap, and/or a fluidic filter. In yet other embodiments, the fluidic network further includes a fluidic trap configured to manipulate a particle, a bead, a droplet, or a cell within the first fluid.

In a third aspect, the present disclosure encompasses a method of transforming an input fluidic signal within a fluidic network, the method including: flowing a first fluid through a flow region adjacent to a deformable region configured to induce flow-limitation as the first fluid is transported; and applying an input fluidic pressure signal to a second fluid located in a gate region adjacent to the deformable region. In some embodiments, the flow-limitation experienced by the first fluid is controlled by the input fluidic pressure signal. In other embodiments, said applying the input fluidic pressure signal generates an output fluidic signal from the flow region of the first fluid.

In some embodiments, the output fluidic signal is controlled by the input fluidic pressure signal applied to the second fluid. In other embodiments, the output fluidic signal is generated from the outlet of the flow region. In yet other embodiments, the output fluidic signal is generated from the inlet of the flow region.

In a fourth aspect, the present disclosure encompasses a method of transforming an input fluidic signal within a fluidic circuit, the method including: applying an input fluidic signal to an inlet of a flow region configured to transport a first fluid, wherein the flow region is adjacent to a deformable region configured to exhibit flow-limitation as the first fluid is transported; and applying a substantially non-varying pressure signal to a second fluid located in a gate region adjacent to the deformable region.

In some embodiments, the flow-limitation experienced by the first fluid is controlled by the input fluidic signal and the pressure applied to the gate region. In further embodiments, said applying the input fluidic pressure signal and the substantially non-varying pressure signal generates an output fluidic signal from an outlet of the flow region.

In a fifth aspect, the present disclosure encompasses a method of controlling flow within a fluidic network, the method including: deforming a deformable region disposed between a flow region and a gate region of a fluidic transistor, thereby inducing flow-limitation of a first fluid being transported within the flow region.

In some embodiments, said deforming includes: applying a first pressure (P_{SD}) between a source and a drain, wherein each of the source and the drain is in fluidic communication with the flow region and wherein the first fluid is transported from the source to the drain; and applying a second pressure (P_{GS}) between the gate region and the source. In particular, applying the first and second pressures can be performed in any order or simultaneously.

In some embodiments, the first pressure (P_{SD}) is from about −100 to 1000 kPa. In other embodiments, the second pressure (P_{GS}) is from about −100 to 1000 kPa.

In a sixth aspect, the present disclosure encompasses a method of manufacturing a fluidic transistor, the method including: providing a deformable region disposed between a flow region and a gate region, wherein the deformable region is configured to induce employ flow-limitation as a first fluid is transported within the flow region.

In some embodiments, the deformable region includes an elastomer, a silicon oxide, a thin metal layer, a thin polymer layer, or a combination thereof.

In other embodiments, the method further includes (e.g., before said providing): forming a flow channel including an inlet serving as a source and an outlet serving as a drain, and wherein the flow region is disposed within the flow channel; and forming a gate channel including an inlet and an outlet, and wherein the gate region is disposed within the gate channel.

In some embodiments, the flow and gate channels are disposed in a single substrate or in different substrates. In particular, said forming the flow channel and said forming the gate channel occurs simultaneously or sequentially in any order.

In some embodiments, the single substrate or the different substrates includes glass, plastic, a semiconductor, a metal, an elastomer, or a combination thereof.

In some embodiments, said providing the deformable region includes: providing a deformable layer disposed between the flow channel and the gate channel, wherein the deformable region is disposed within the deformable layer. In particular embodiments, the deformable layer includes an elastomer, a silicon oxide, a thin metal layer, a thin polymer layer, or a combination thereof.

In some embodiments, the flow channel is substantially perpendicular or substantially parallel to the gate channel. In other embodiments, the flow channel and the gate channel intersect to form a junction. In yet other embodiments, said providing the deformable region includes: flowing a first reagent through the flow channel; and flowing a second reagent through the gate channel, wherein the first and second reagents react at the junction to form the deformable region.

In some embodiments, the deformable region is configured to self-deflect upon applying pressure between the source and the drain.

In any embodiment herein, the fluidic transistor is characterized by an intrinsic gain that is greater than 1 (e.g., and optionally less than 50).

In any embodiment herein, the fluidic transistor is a microfluidic transistor.

In any embodiment herein, the deformable region includes an elastomer, a silicon oxide, a thin metal layer, a thin polymer layer, a silicon layer, or a combination thereof.

In any embodiment herein, the first fluid and/or the second fluid includes a gas, a liquid, a gas mixture, a liquid mixture, a biphasic mixture, an emulsion, a suspension of particles, a biological fluid containing cells, viruses, genetic material, proteins, lipids, beads, cells, or a combination thereof.

In any embodiment herein, the deformable region includes a flexural rigidity of about 10⁻²³ J to 10⁻³ J, a Young's modulus of about 100 kPa to about 500 GPa, and/or a Poisson ratio of about 0.2 to about 0.5.

In any embodiment herein, the flow and gate channels are disposed in a single substrate or in different substrates.

In any embodiment herein, the deformable region is configured to minimize fluidic communication between the flow and gate channels.

In any embodiment herein, the fluidic transistor is characterized by a Shapiro number S that is greater than or equal to 1.

Additional details follow.

### Definitions

As used herein, the term “about” means+/−10% of any recited value. As used herein, this term modifies any recited value, range of values, or endpoints of one or more ranges.

As used herein, the term “channel” refers to a gap through which a fluid may flow. A channel may be a capillary, a conduit, or a chamber in which a fluid can be confined.

By “fluidic communication,” as used herein, refers to any duct, channel, tube, pipe, chamber, or pathway through which a substance, such as a liquid, gas, or solid may pass substantially unrestricted when the pathway is open. When the pathway is closed, the substance is substantially restricted from passing through. Typically, limited diffusion of a substance through the material of a plate, base, and/or a substrate, which may or may not occur depending on the compositions of the substance and materials, does not constitute fluidic communication.

By “microfluidic” or “micro” is meant having at least one dimension that is less than 1 mm. For instance, a microfluidic structure (e.g., any structure described herein) can have a length, width, height, cross-sectional dimension, circumference, radius (e.g., external or internal radius), or diameter that is less than 1 mm.

As used herein, the terms “top,” “bottom,” “upper,” “lower,” “above,” and “below” are used to provide a relative relationship between structures. The use of these terms does not indicate or require that a particular structure must be located at a particular location in the apparatus.

As used in the specification and the appended claims, the singular forms “a,” “an” and “the” include plural referents unless the context clearly dictates otherwise. Thus, for example, reference to “a nanoparticle” includes mixtures of nanoparticles, reference to “a nanoparticle” includes mixtures of two or more such nanoparticles, and the like.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Where values are described in the present disclosure in terms of ranges, endpoints are included. Furthermore, it should be understood that the description includes the disclosure of all possible sub-ranges within such ranges, as well as specific numerical values that fall within such ranges irrespective of whether a specific numerical value or specific sub-range is expressly stated.

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control. In addition, the materials, methods, and examples are illustrative only and not intended to be limiting.

Various embodiments of the features of this disclosure are described herein. However, it should be understood that such embodiments are provided merely by way of example, and numerous variations, changes, and substitutions can occur according to those skilled in the art without departing from the scope of this disclosure. It should also be understood that various alternatives to the specific embodiments described herein are also within the scope of this disclosure.

Other features and advantages of the present disclosure will be apparent from the following detailed description, the figures, and the claims.

### BRIEF DESCRIPTION OF THE DRAWINGS

The following drawings illustrate certain embodiments of the features and advantages of this disclosure. These embodiments are not intended to limit the scope of the appended claims in any manner. Like reference symbols in the drawings indicate like elements.

FIG. 1A-1F shows non-limiting schematics of exemplary fluidic transistors. Provided are (A) a perspective view of a non-limiting fluidic transistor 100; (B) a perspective view of a non-limiting fluidic network 105 having a fluidic transistor; (C) a cross-sectional view along line 1C-1C in FIG. 1B; (D) a cross-sectional view along line 1D-1D in FIG. 1B; (E) a cross-sectional view of a fluidic transistor in the presence of flow 15; and (F) a perspective view of another non-limiting fluidic network 1000 having a fluidic transistor.

FIG. 2A-2B shows non-limiting schematics of other exemplary fluidic transistors. Provided are (A) a perspective view of a non-limiting fluidic transistor 200; and (B) a perspective view of another non-limiting fluidic transistor 2000.

FIG. 3A-3C shows non-limiting schematics of exemplary fluidic networks having a deformable layer. Provided are (A) a perspective view of a non-limiting fluidic network 300; (B) a cross-sectional view along line 3B-3B in FIG. 3A; and (C) a cross-sectional view of another non-limiting fluidic network 3000.

FIG. 4A-4F shows non-limiting schematics of other exemplary fluidic networks. Provided are (A) a perspective view of a non-limiting fluidic network 400; (B) a perspective view of another non-limiting fluidic network 4000; (C) a perspective view of yet another non-limiting fluidic network 4100; (D) a perspective view of a non-limiting fluidic network 4200A having a junction 4210; (E) a perspective view of a non-limiting fluidic network 4200B having a deformable region 4250; and (F) a perspective view of another non-limiting fluidic network 4300 having a junction 4310.

FIG. 5 shows that elastomeric channels can exhibit pressure-controlled flow-limitation analogous to an electronic transistor. Provided is (A) a schematic showing non-limiting geometry of the microfluidic transistor, fabricated from three layers of elastomer (top layer, membrane, and bottom layer). Pressure applied between the gate and the source deflects the membrane, restricting flow (arrow) from the source to the drain. Also provided is (B) a schematic symbol for the microfluidic transistor. The pressure difference from the gate to the source is P_{GS}, and the pressure difference between the source and the drain is P_{SD}. Volumetric flow through the drain is Q. Also provided are (C) experimentally measured characteristic curves of the microfluidic transistor, demonstrating all three operation regimes seen in electronic transistors (linear, cut-off, and saturation). Each curve was obtained by measuring flow Q, while holding P_{GS} constant and sweeping P_{SD}. Finally, provided is (D) a contour plot of the intrinsic gain of the microfluidic transistor as a function of P_{GS} and P_{SD}, showing large regions with intrinsic gain greater than one.

FIG. 6 shows additional characterization of a non-limiting microfluidic transistor. Provided are (A) additional characteristic curve measurements for a single transistor. P_{SD} was swept from 0 to 80 kPa for each curve, while P_{GS} was held at constant values from 0 to 80 kPa in increments of 5 kPa. The flow through the drain Q was measured. Also provided are (B) transconductance characteristics for a non-limiting microfluidic transistor. P_{GS} was swept from 0 to 80 kPa for each curve, while P_{SD} was held at constant values from 20 to 80 kPa in increments of 20 kPa. The flow through the drain Q was measured.

FIG. 7 shows an example of microfluidic transistors that exhibit flow-limitation as the Shapiro number exceeds one. In the regime where the Shapiro number is less than one, the pressure-flow characteristics of the microfluidic transistor follow the linear relationship predicted by the Poiseuille equation (line that is labeled “Ideal Poiseuille Resistor”). As the Shapiro number exceeds one (dashed line), the pressure-flow characteristics deviate in a non-linear fashion, and the system exhibits flow-limitation.

FIG. 8A-8E shows non-limiting microfluidic transistor-based circuits that replicate the behavior of classic electronic circuits. For each circuit, the schematic diagram (left), a photo of the microfluidic implementation (middle, false color, scale bars 1 mm), and the demonstration of circuit function (right) is provided. Provided is (A) a fluidic amplifier circuit. The input pressure signal (labeled “Pᵢₙ”) is amplified with a gain of 22 to generate the output signal (labeled “Pₒᵤₜ”). Also provided is (B) a flow regulator. The varying input pressure (labeled “Pᵢₙ”) is regulated to supply a target flow (labeled “Qₒᵤₜ”) of 12 μL/s to a load. Provided is (C) a level-shifter circuit. The baseline of the input pressure signal (labeled “Pᵢₙ”) is shifted up by 80 kPa to produce an output pressure signal (labeled “Pₒᵤₜ”). Provided is (D) a NAND gate circuit. The output signal (labeled “Pₒᵤₜ”) is low only if both input signals (labeled “A” and “B”) are high. Finally, provided is (E) an SR-latch circuit. The persistent state of the latch (labeled “Pₒᵤₜ”) can be set to high or low pressure based on transient pulses applied to Set (labeled “Set”) or Reset (labeled “Reset”).

FIG. 9 shows additional characterization of a non-limiting differential amplifier. Provided are (A) distortion characteristics of the differential amplifier. The differential input was swept from −10 to 10 kPa, while the differential output was measured. Also provided is (B) common-mode rejection of the differential amplifier. The common-mode input was swept from 160 to 200 kPa, while the differential output was measured. Finally, provided is (C) a Bode plot of the differential amplifier. A square wave with a period of 30 seconds was fed to the differential input, while the output signal was measured. The signals were converted to the frequency domain, and the first 40 odd harmonics were used to create the Bode plot.

FIG. 10 shows additional characterization of a non-limiting flow regulator. Provided is (A) line regulation of the flow regulator. The line pressure was swept from 0 to 150 kPa under a load, while the flow was measured. Also provided is (B) load regulation of the flow regulator. The load pressure was swept from 0 to 50 kPa, while the line supplied a constant pressure of 100 kPa; and the flow was measured.

FIG. 11 shows additional characterization of a non-limiting level-shifter. Provided is (A) pressure shift of the level-shifter. The input pressure was swept from 10 to 90 kPa, while the output pressure was measured. Also provided is (B) gain of the level-shifter. The input pressure was swept from 10 to 90 kPa, while the output pressure was measured. The ratio of the slopes of the input and output pressures was used to calculate the gain. Note that since the circuit operates in a common-drain topology, the pressure gain in decibels is expected to be negative.

FIG. 12 shows additional characterization of a non-limiting NAND gate. Provided are (A, B) slew of the NAND gate. Input signal B was set to high, while input signal A was toggled between high and low, causing the output to toggle between low and high. Fifty-five individual rising (A) and falling (B) output edges were plotted to observe the slew dynamics. Also provided are (C) input A transfer characteristics. While holding input B high, input A was swept from 125 to 175 kPa ten times. The resulting output signal curves were overlaid and plotted. Finally, provided are (D) input B transfer characteristics. While holding input A high, input B was swept from 175 to 125 kPa ten times. The resulting output signal curves were overlaid and plotted.

FIG. 13 shows additional characterization of a non-limiting SR-latch. Provided are (A) reset slew and hold time of the SR-latch. The latch was first initialized to a high output state, then a reset pulse was applied to reset the latch to a low output state. The output for sixty such events were recorded and overlaid. Also provided are (B) set slew and hold time of the SR-latch. The latch was first initialized to a low output state, then a set pulse was applied to set the latch to a high output state. The inverted outputs for sixty such events were recorded and overlaid.

FIG. 14A-14F provides non-limiting fluidic circuits having a plurality of fluidic transistors. Provided is (A) a non-limiting schematic of an oscillator circuit (left), a photo of the microfluidic implementation (center), and typical output oscillation signal (right) designed for a frequency of 0.1 Hz and a duty cycle of 50% (other frequencies and duty cycles may be implemented). Also provided is (B) a non-limiting schematic of a flip-flop circuit. An output signal may be “low” or “high” depending on the state of the circuit. If a current pulse is applied to a Set state, then the output moves to, and remains at, high. If a current pulse is applied to Reset state, then the output signal moves to, and remains at, low. Provided is (C) a non-limiting schematic of a well (or a trap) and surrounding circuitry, which can operate to trap a cell. The three channels extending from the well (input, product, and waste) can be configured to interface with the schematic circuitry through the three arrows. Since all the circuitry is realized with fluidic components, cells and liquids may flow through the circuit elements themselves. For example, a cell that enters the cell input port eventually travels to the well after passing through a transistor. An amplifier circuit can be used to amplify the pressure difference between the input and waste channels of the well. Additional circuitry can be used to trigger the closing of the input and waste channels. Finally, provided are non-limiting schematics of (D) a common-source topology, (E) a common-gate topology, and (F) a common-drain topology.

FIG. 15 shows microfluidic transistors that enable smart dispenser circuits for autonomous single particle manipulation. Provided is (A) an overview of the smart dispenser operation, depicting the core microfluidic trap in different states (scale bars 50 μm). Also provided is (B) a non-limiting circuit schematic of the smart dispenser including several circuit blocks and the microfluidic trap (circle having three terminals within the circuit block labeled “Particle Trap”). After a particle is trapped, the pressure upstream of the trap (P_{plug}) rises in a repeatable fashion. The amplifier and the level shifters process the P_{plug} signal to produce the trigger signals P_{Trig} and P_{T̅r̅i̅g̅}. Provided is (C) deterministic single-particle ordering and concentration using the smart dispenser. This dispenser configuration has the Trig and Sense lines directly connected, so that individual particles are sensed and immediately ejected into the output channel. Pressure signals from the trap itself (P_{plug}) and the trigger (P_{Trig}) for a run of 230 particles are shown, along with a representative dispense event to observe the dynamics (inset provided to the right of the curved arrow). Finally, provided are (D) histograms of input and output particle spacing when using the smart dispenser in this configuration, showing a 6-fold drop in the spacing mean (indicating particle concentration) and a 17-fold drop in the spacing standard deviation (indicating particle ordering).

FIG. 16 shows repeatability of a non-limiting smart particle dispenser. Provided are (A) collated plug signals for individual events. The P_{plug} pressure signal for n=230 trapping events were aggregated, and a pointwise median signal with 90% and 10% quantile bands were plotted. Also provided are (B) collated trigger signals for individual events. These signals for n=230 trapping events were aggregated, and a pointwise median signal with 90% and 10% quantile bands were plotted.

FIG. 17 shows a non-limiting assembly of multilayer microfluidic transistor-based circuits. Soft-lithography techniques were used to fabricate the top and bottom layers out of poly(dimethyl siloxane) (PDMS). Top layer ports were punched into the top PDMS layer. Then, the layer was bonded with a thin silicone membrane under oxygen plasma. Ports for the bottom layer were then punched into the top layer-membrane assembly. The assembly was aligned by hand and finally bonded with the bottom layer under oxygen plasma.

FIG. 18 shows a non-limiting setup for single transistor characterization measurements. Relevant component details, such as geometry and resistance values, are provided in Table 1.

FIG. 19 shows a non-limiting setup for amplifier characterization measurements. Provided is (A) a pinout diagram of amplifier chip with ports labeled. The two layers of fluidic channels are colored dark gray and light gray. Also provided are (B) fluidic setup for demonstration and distortion measurements, (C) fluidic setup for common-mode rejection measurements, and (D) fluidic setup for Bode plot (frequency response) measurements. Relevant component details, such as geometry and resistance values, are provided in Table 2.

FIG. 20 shows a non-limiting setup for flow regulator measurements. Provided is (A) a pinout diagram of flow regulator chip with ports labeled. The two layers of fluidic channels are dark gray and light gray. Also provided are (B) fluidic setup for demonstration and line regulation measurements and (C) fluidic setup for load regulation measurements. Relevant component details, such as geometry and resistance values, are provided in Table 2.

FIG. 21 shows a non-limiting setup for level-shifter measurements. Provided is (A) a pinout diagram of a level-shifter chip with ports labeled. The two layers of fluidic channels are colored dark gray and light gray. Also provided is (B) fluidic setup for demonstration, shift amount, and gain measurements. Relevant component details, such as geometry and resistance values, are provided in Table 2.

FIG. 22 shows a non-limiting setup for NAND gate measurements. Provided is (A) a pinout diagram of NAND gate chip with ports labeled. The two layers of fluidic channels are colored dark gray and light gray. Provided are (B) fluidic setup for demonstration and slew measurements and (C) fluidic setup for transfer characteristics measurements. Relevant component details, such as geometry and resistance values, are provided in Table 2.

FIG. 23 shows a non-limiting setup for SR-latch measurements. Provided is (A) a pinout diagram of SR-latch chip with ports labeled. The two layers of fluidic channels are colored dark gray and light gray. Provided is (B) fluidic setup for demonstration and slew measurements. Relevant component details, such as geometry and resistance values, are provided in Table 2.

FIG. 24A-24B shows a non-limiting setup for smart particle dispenser measurements. Provided is (A) a pinout diagram of the particle trap with ports labeled (NC: no connection). The two layers of fluidic channels are colored dark gray and light gray. (B) The smart particle dispenser uses several blocks to perform signal processing. An amplifier is used to amplify the change in pressure (P_{plug}) when a particle is blocked in the trap, generating a pair of differential analog signals. A latch is used to produce complementary digital signals. The level-shifters then shift the baseline pressure of the digital signals back to a range where they can control the direction of flow through the trap. Bottles are used as reservoirs for the “Supply” sources. Light gray reservoirs hold particle suspensions. In this configuration, the Trig and Sense signals are directly connected to each other to perform particle ordering and concentration. Relevant component details, such as geometry and resistance values, are provided in Table 3.

FIG. 25 shows that elastomeric channels exhibit pressure-controlled flow-limitation analogous to an electronic transistor. Provided is (a) a cross-sectional view of the components of a non-limiting microfluidic transistor, fabricated from three layers of PDMS bonded under oxygen plasma. The length, width, and height of the transistor is L, W, and H respectively, and the thickness of the membrane is D. Pressure in the gate channel deflects the membrane, restricting flow (gray arrow) from the inlet to the outlet of the flow channel. Also provided is (b) a schematic symbol of the microfluidic transistor. The pressure differential between the gate and inlet is P_{g1}, the pressure differential between the inlet and outlet is P₁₂ and the flow through the flow channel is Q. Also provided are (c) characteristic curves of a PDMS microfluidic transistor. Each curve is obtained by measuring flow Q, while holding P_{g1} constant and sweeping P₁₂. Finally, provided is (d) a contour plot of intrinsic gain of a PDMS microfluidic transistor. The flow Q was sampled at a grid of different P_{g1} and P₁₂ values, then the symmetric difference quotient was used to compute the intrinsic gain Aₘ for each sampled point.

### DETAILED DESCRIPTION

The present disclosure relates to a fluidic transistor that amplifies an input fluidic signal, such as by amplifying a pressure signal and/or a flow signal. Such fluidic transistors can be employed in a fluidic network, thereby forming a fluidic circuit for signal processing in which only fluids are employed as input and output signals.

Under certain geometric configurations that are described herein, the fluidic transistor is capable of amplifying a pressure or flow signal in a fluidic circuit, analogous to how an electronic field effect transistor is capable of amplifying a voltage or current signal in an electrical circuit. The fluidic transistors disclosed herein are specifically designed to use the fluidic phenomenon of flow-limitation to exhibit pressure-flow characteristics that are analogous to the voltage-current characteristics of electronic field-effect transistors.

Just as electronic transistors are configured in electronic networks to manipulate electronic signals perform electronic signal processing operations, the present disclosure relates to a range of fluidic networks including one or more fluidic transistors. These fluidic networks and combinations thereof can be used to perform signal processing operations on fluidic signals, for the control and manipulation of small volumes of fluid in biological, chemical, and medical processes.

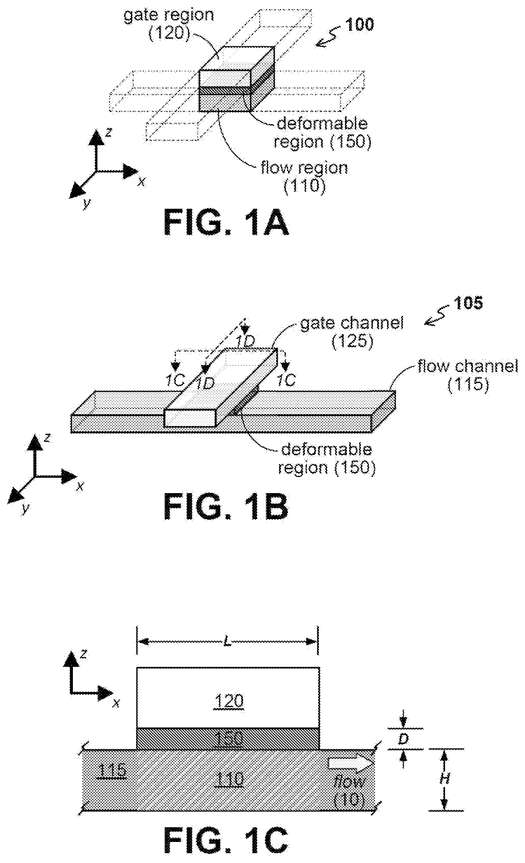

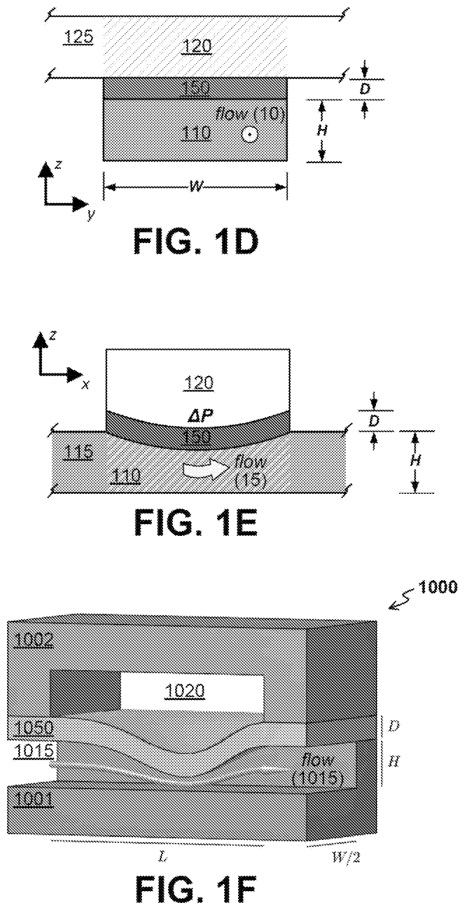

FIG. 1A provides a non-limiting schematic of a fluidic transistor 100. As can be seen, the fluidic transistor 100 includes a flow region 110, a gate region 120, and a deformable region 150 disposed between the flow and gate regions 110, 120.

As described herein, fluids can be employed to provide fluidic signals to the flow and gate regions. Thus, in one embodiment, the flow region 110 is configured to transport a first fluid, and the gate region 120 is configured to contain or confine a second fluid. In use, the first fluid is transported through the fluidic transistor and travels through a fluidic network that is in fluidic communication with the fluidic transistor. By applying pressure to the first fluid, flow of this fluid may be induced. Thus, flow of the first fluid can used to manipulate reagents, substances, cells, droplets, particles, etc. that are within that first fluid. In contrast, the second fluid is typically used to gate the fluidic transistor, such that this second fluid is typically not transported. Rather, in some non-limiting embodiments, the second fluid is typically confined within a channel having a closed end. Thus, pressure applied to the second fluid will be transmitted throughout the second fluid (and to the deformable region) but will not typically result in volumetric flow of the second fluid.

The first and second fluids can be the same or different. In some embodiments, a sample will be provided as the first fluid, and a control fluid (e.g., air, inert gas, water, buffer, oil, inert liquid, etc.) will be provided as the second fluid. In this way, the sample flows through the flow region of the transistor and can be manipulated through the fluidic network to perform any useful fluidic operations (e.g., particle manipulation, combining and splitting of different flow streams, flow rate amplification, fluidic pressure amplification, flow switching, flow trapping, and the like). In some embodiments, both the first and second fluids are part of the same fluidic network, such that the respective fluidic signals exhibit feedback control. In this way, complex fluidic signal processing and analog signal generation operations (e.g., negative feedback amplifiers, flow regulators, flow mirrors, signal filters, logic gates, oscillators, multiplexers, counters) can be achieved in fluidic networks, akin to the way electronic transistors enable complex signal processing and signal generation in electrical networks.

Non-limiting examples of first and second fluids can include a gas, a liquid, a gas mixture (e.g., air, oxygen, carbon dioxide, nitrogen gas, helium gas, argon gas, an inert gas, a reactive gas (e.g., ammonia, hydrogen, methane, halogen, and the like), and others), a liquid mixture (e.g., an aqueous mixture, an organic mixture, drugs, precursor solutions, buffers, salt solutions, acids, bases, as well as mixtures including a solute such as a drug, a reagent, and the like with a solvent), a biphasic mixture (e.g., having at least two different phases and/or having droplets including microdroplets, single droplets, multi-emulsion droplets, and/or droplet slugs, in which surfactant(s) may be optionally present), an emulsion (e.g., lipid nanostructures like micelles, exosomes, colloids, synthetic membranes, lipid nanoparticles, mRNA lipid nanoparticles, and the like, in which surfactant(s) may be optionally present), a suspension of particles (e.g., solid or semisolid particle), a biological fluid containing cells (e.g., blood, plasma, sputum, and the like), viruses, genetic material, proteins, lipids, beads, droplets, cells, or a combination of any of these.

The first and second fluids interact with the deformable region, in which such interaction deforms the deformable region and can alter the flow or pressure fields of the first fluid. In the present disclosure, the deformable region is configured to induce the fluidic phenomenon of flow-limitation as the first fluid is transported within the flow region. This fluidic phenomenon leads to a favorable non-linear alteration in the pressure and/or flow fields of the first fluid. This non-linear alteration in the pressure and/or flow fields of the first fluid causes the fluidic transistor to exhibit pressure-flow characteristics analogous to those of the electronic transistor.

The phenomenon of flow-limitation arises under certain geometric, hydrodynamic, and elastic conditions of a fluid-structure system where a fluid flow occurs in proximity to a deformable structure. In particular, flow-limitation occurs when the maximum fluid velocity in the flow region approaches or exceeds a characteristic propagation velocity of the fluid-structure system. The propagation velocity of a fluid-structure system is an intrinsic property of the system that can be calculated from the hydrodynamic properties of the fluid, the elastic properties of the structure, and the geometrical relationship between the fluid and the structure (here, of the deformable region). The propagation velocity has been analytically determined for systems with simple geometries (see, e.g., ref. 18, 19, 34, 35) or may be computed using finite-element methods for more complex geometries (see, e.g., ref. 36 and 37). The Shapiro number (S) of a system is then defined as a dimensionless ratio between the maximum velocity of the fluid and the propagation velocity of the system (see, e.g., ref. 20).

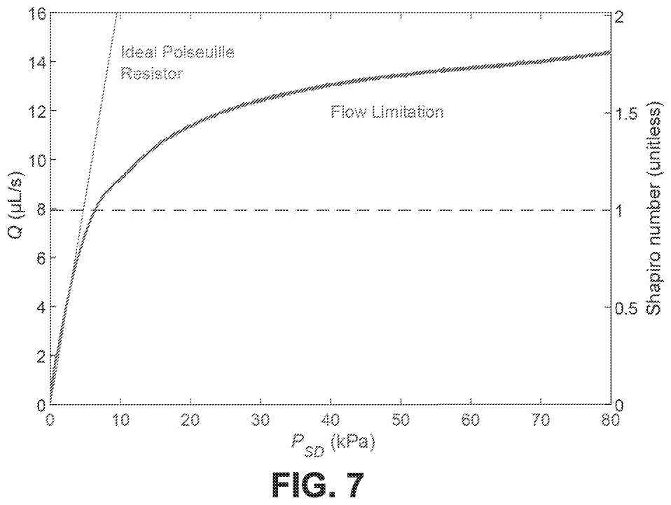

One of the parameters that influence S is the flow rate of the fluid (e.g., the first fluid) in the system (see, e.g., ref. 18). If low flow rates are applied to the system such that S is much less than one (S<<1), the system would exhibit a relationship between pressure and flow substantially similar to the relationship expected for a system with totally rigid structures. Often, this relationship is linear as in the case of laminar flow in a rigid pipe (Hagen-Poiseuille flow). However, if the flow rate is high enough that S exceeds one (S>1), the relationship between pressure and flow in the system deviates non-linearly from what would be expected in the rigid system, due to the substantial deformation of the deformable structure. Typically, this results in a lower flow rate than the rigid case, a well-known feature of flow-limitation (see, e.g., ref. 18). This phenomenon has been demonstrated by an embodiment in, e.g., FIG. 7.

Accordingly, this present disclosure encompasses fluid-structure systems (e.g., a fluidic transistor) where the S≥1. In one non-limiting embodiment, the fluid-structure system includes a channel (e.g., a fluid-filled channel) with a rectangular cross-section adjacent to a deformable elastic membrane with substantially equal length and width. In the non-limiting case where the pressure difference between the inlet and the outlet of the channel is much larger than the pressure difference between the inlet of the channel and the outlet, S (a dimensionless number) is given as follows:

$$S = {Q ( \frac{{H}^{3}}{ρ} \frac{2 {π}^{4}}{{W}^{2}} )}^{- \frac{1}{2}} , \qquad [ 1 ]$$

where Q is the flow rate, H is the channel height, ρ is the fluid density, B is the flexural rigidity of the membrane, and W is the channel width.

As there are several different hydrodynamic, elastic, and geometrical parameters involved, there is considerable flexibility in the design process to insert values for the parameters most suitable for the fabrication/application chosen, then determine optimal values for the remaining parameters such that S still exceeds one. For example, if one non-limiting application includes control of liquid water at a flow rate of 1 nL/s and a channel width of 1 μm, then the Shapiro number condition can be equally satisfied with a height of 10 nm and a flexural rigidity of 5·10⁻¹² J, as well as a height of 1 μm and a flexural rigidity of 5·10⁻¹⁸ J. Both implementations fall within the scope of this disclosure.

In some embodiments, the deformable region can be configured to provide desired characteristics exhibited by the first fluid. For example, the fluidic transistor can possess a characteristic dimension (e.g., characteristic width, length, height, cross-sectional area, etc.) and/or include certain properties of the deformable region (e.g., flexural rigidity, Poisson's ratio, Young's modulus etc.) to provide S≥1. In one non-limiting embodiment, the deformable region has flexural rigidity of about 10⁻²³ J to 10⁻³ J. In another non-limiting embodiment, the deformable region has a Young's modulus of about 100 kPa to about 500 GPa and/or a Poisson ratio of about 0.2 to about 0.5.

In some embodiments, the deformable region is configured to restrict but not eliminate flow of the first fluid in the flow region. In yet other embodiments, the deformable region is configured to minimize fluidic communication between the flow and gate regions.

In yet other embodiments, the deformable region is configured to provide the first fluid at a velocity that is at or faster than a characteristic propagation velocity for the flow region. As described herein, the characteristic propagation velocity is an intrinsic property of the system, and this propagation velocity can be calculated from the hydrodynamic properties of the fluid, the elastic properties of the structure, and the geometrical relationship between the fluid and the structure (here, of the deformable region).

The second fluid also interacts with the deformable region, in which such interaction acts to deform the deformable region. In some instances, the flow-limitation experienced by the first fluid (through the flow region) can be controlled by applying a pressure to the deformable region, and this applied pressure is supplied by the second fluid within the gate region. Thus, in some embodiments, deformation of the deformable region via the pressure of the second fluid induces the flow-limitation of the first fluid in the flow region. Even when pressure is not applied to the second fluid, in some instances, the flow of the first fluid adjacent to the deformable region will also act to deform this deformable region. In certain non-limiting embodiments, the deformable region can be configured to self-deflect upon applying pressure between a source and a drain of the flow region.

The first and second fluids can be delivered to the deformable region in any useful manner. In one instance, channels can be used. As seen in FIG. 1B, a fluidic network 105 can include a fluidic transistor, in which the flow region is disposed within a flow channel 115 and a gate region is disposed within a gate channel 125. The deformable region 150 is disposed between the flow and gate region.

The flow and gate channels can have inlets or outlets. In some embodiments, the flow channel includes an inlet serving as a source and an outlet serving as a drain, and the flow channel can be configured to transport the first fluid from the source to the drain. In other embodiments, the gate channel includes an inlet and an outlet, and the gate channel is configured to confine the second fluid between the inlet and the outlet. In some embodiments, the outlet of the gate channel is a closed end.

Using such inlets and outlets, pressure can be applied to the deformable region in different ways. In one instance, the deformable region can be configured to deflect upon applying pressure between the gate region and the source of the flow region. In another instance, the deformable region can be configured to self-deflect upon applying pressure between the source and the drain in fluidic communication with the flow region.

FIG. 1C shows a cross-sectional view of the gate region 120, the underlying flow region 110, and the deformable region 150 disposed therebetween. As can be seen, the flow region 110 is disposed within the flow channel 115. Flow 10 of the first fluid results in fluid transport within the flow channel 115 and through the flow region 110.

The fluidic transistor can have any useful characteristic dimension. As seen in FIG. 1C, the fluidic transistor can be characterized by a particular dimensions, such as length L, height H, and deformable region thickness D. In one instance, the flow region comprises a characteristic dimension from about 10 nm to about 1 mm and/or a cross-sectional area of about 100 nm² to about 1 mm². In one non-limiting embodiment, a characteristic length is the average dimension of the deformable region in contact with the flow region measured parallel to fluid flow. In another non-limiting embodiment, a characteristic width is the average dimension of the deformable region in contact with the flow region measured perpendicular to fluid flow and deformation direction. In yet another non-limiting embodiment, a characteristic height is the maximum deformation possible of the deformable region in contact with the flow region. In other embodiments, the fluidic transistor can be a microfluidic transistor, in which at least one dimension (e.g., channel width, channel height, transistor length, thickness of deformable region, and the like) is less than 1 mm.

FIG. 1D shows a cross-sectional view of the gate region 120, the underlying flow region 110, and the deformable region 150 disposed therebetween. As can be seen, the gate region 120 is disposed within the gate channel 125. As also seen in FIG. 1D, the fluidic transistor can be characterized by a particular length L, height H, and deformable region thickness D.

FIG. 1E shows one non-limiting instance in which the deformable region can be deformed. In this instance, pressure can be applied to the second fluid within the gate channel, such that a force (e.g., as characterized by a pressure difference) is observed at the interface between the gate region 120 and the deformable region 150, thereby deforming the deformable region. This deformation, in turn, alters the extent of flow-limitation of the first fluid in the flow region 110, in which the characteristics of that flow 15 is regulated by the applied pressure to the deformable region 150 by the gate region 120.

FIG. 1F shows another non-limiting instance in which deformation of the deformable region results in inducing flow-limitation. Here, the fluidic 1000 network includes a top layer 1002 having a gate region 1020 formed therein, a membrane layer 1050 having a deformable region formed therein, and a bottom layer 1001 having a flow channel 1015 and a flow region formed therein. A pressure difference (e.g., due to pressure applied to the second fluid within the gate region or applied between the gate region and an inlet of the flow channel 1015) can deflect the deformable region (which, here, is a portion of the membrane layer 1050), thereby restricting flow 1015 through the flow channel (e.g., between a source and a drain of the flow channel).

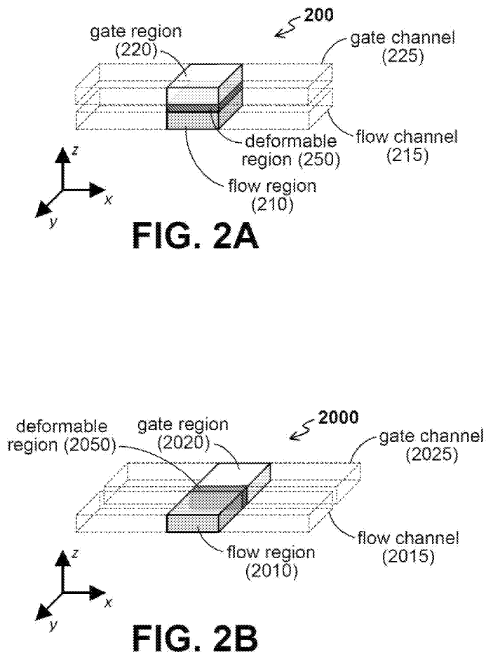

The flow region and the gate region can be arranged in any useful manner, so long as a deformable region is disposed between the flow and gate region. Thus, in some embodiments, the flow region is disposed above or below the gate region. In other embodiments, the flow region is disposed beside the gate region. For instance, FIG. 2A provides a non-limiting schematic of a fluidic transistor 200. As can be seen, the fluidic transistor 200 includes a flow region 210 disposed within a flow channel 215, a gate region 220 disposed within a gate channel 225, and a deformable region 250 disposed between the flow and gate regions 210,220. Here, the flow region 210 is disposed below the gate region 220.

In another instance, FIG. 2B provides a non-limiting schematic of a fluidic transistor 2000. As can be seen, the fluidic transistor 2000 includes a flow region 2010 disposed within a flow channel 2015, a gate region 2020 disposed within a gate channel 2025, and a deformable region 2050 disposed between the flow and gate regions 2010, 2020. Here, the flow region 2010 is disposed beside the gate region 2020.

The flow region can have any useful characteristic dimension (e.g., characteristic height, width, cross-sectional area, and the like). In some instance, the flow region has a height or a width from about 10 nm to about 1 mm and/or a cross-sectional area of about 100 nm² to about 1 mm². Other ranges and characteristic dimensions are described herein.

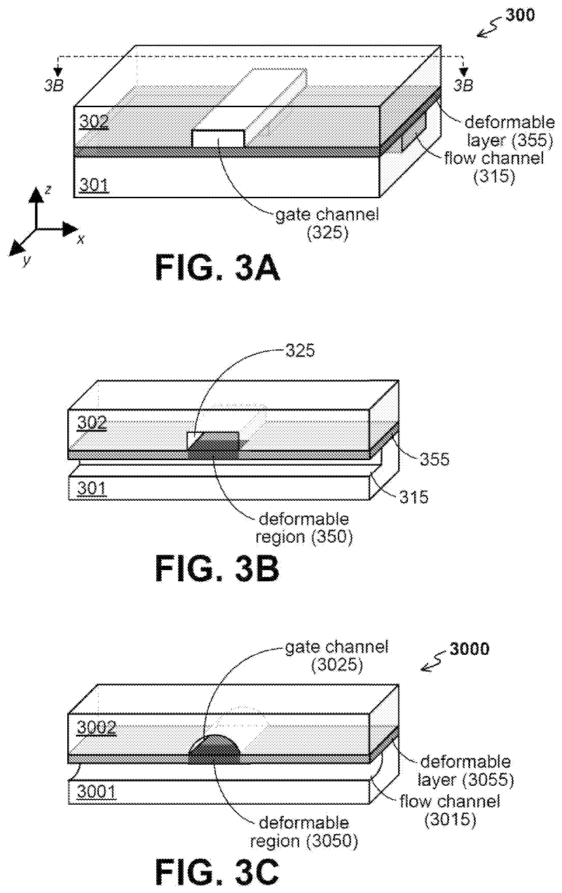

FIG. 3A provides a fluidic network 300 formed by using a top substrate 302, a bottom substrate 301, and a deformable layer 355 disposed therebetween. As can be seen, a gate channel 325 is disposed within the top substrate 302, and a flow channel 315 is disposed within the bottom substrate 301. Here, the flow and gate channels are disposed in different substrates. Of course, the composition of these substrate 301,302 may be the same (e.g., both the same type of polymer or glass) or different (e.g., each substrate is a different type of polymer, different type of glass, or one substrate is a polymer and the other is glass). The substrate(s) herein can be formed of any useful material, such as glass, plastic, a semiconductor, a metal (e.g., a conductive metal, a non-conductive metal, a metal alloy, and the like), an elastomer, or a combination thereof (e.g., multilayers thereof, laminated forms thereof, mixtures thereof, etc.).

FIG. 3B provides a cross-sectional view of the fluidic network 300, in which a deformable region 350 is disposed at the junction in which the gate channel 325 crosses over the flow channel 315. The portion of the deformable layer 355 at this junction is the deformable region 325. Thus, the deformable layer 355 is disposed between the flow channel 315 and the gate channel 325, and the deformable region 350 is disposed within the deformable layer 355.

The flow and gate channels can have any useful arrangement and geometry. In one instance, the flow channel is substantially perpendicular to the gate channel. In another instance, the flow channel is substantially parallel to the gate channel. The cross-section of the flow region, flow channel, gate region, and/or gate channel can be of any useful geometry (e.g., substantially square, quadrilateral, circular, semi-circular, curvilinear, as well as others described herein). In some embodiments, substantially perpendicular channels can include two channels having an angle of about 90°. In some embodiments, substantially parallel channels can include two channels having an angle of about 180°.

The cross-section of the flow region, flow channel, gate region, and/or gate channel can vary in the direction of flow (e.g., along the x-axis in FIG. 1B for the first fluid or along the y-axis in FIG. 1B for the second fluid), thereby create a contracting taper, an expanding taper, or another geometrical volume (e.g., from one cross-section to another cross-section, such as from a square cross-section to a rectangular cross-section). In some embodiments, the flow channel is configured to provide the first fluid at a flow rate of about 1 fL/s to about 1 mL/s.

Any useful cross-sections may be employed. As seen in FIG. 3B, the flow and gate channels have a cross-section that is substantially rectangular. In FIG. 3C, the flow and gate channels have a cross-section that is substantially semi-circular. FIG. 3C provides a cross-sectional view of the fluidic network 3000, in which a deformable region 3050 is disposed at the junction in which the gate channel 3025 (defined within a top substrate 3002) crosses over the flow channel 3015 (defined within a bottom substrate 3001). The portion of the deformable layer 3055 at this junction is the deformable region 3025.

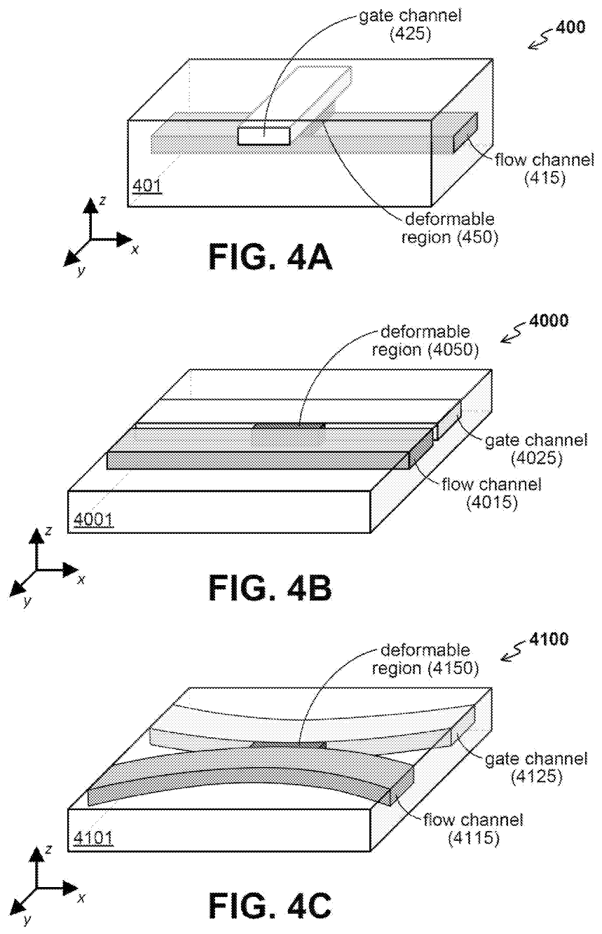

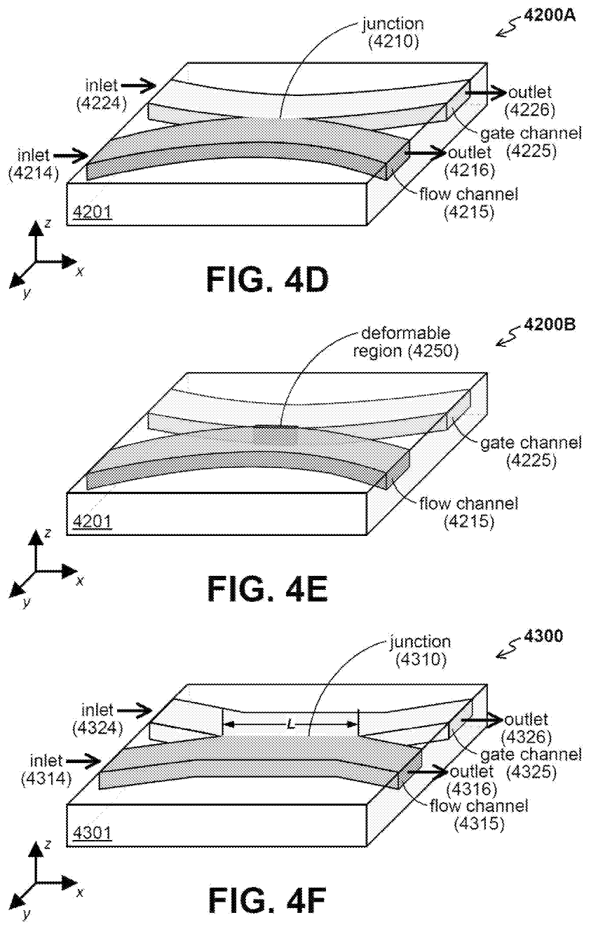

The flow and gate channels can be disposed in a single substrate. As seen in FIG. 4A, the gate channel 425 and the flow channel 415 are defined within a single substrate 401. FIG. 4A provides a perspective view of the fluidic network 400, in which a deformable region 450 is disposed at the junction in which the gate channel 425 crosses over the flow channel 415.

In another instance, as seen in FIG. 4B, the gate channel 4025 and the flow channel 4015 are defined within a single substrate 4001, and the channels are substantially parallel to each other. FIG. 4B provides a perspective view of the fluidic network 4000, in which a deformable region 4050 is disposed between the gate channel 4025 and the flow channel 4015. Channels or even portions of channels may be substantially parallel. For instance, as seen in FIG. 4C, the gate channel 4125 and the flow channel 4115 are defined within a single substrate 4101, and the channels are substantially parallel to each other for a short region. Within this region, a deformable region 4150 is disposed between the gate channel 4125 and the flow channel 4115.

For channels disposed in a single substrate, the deformable region can be formed in any useful manner. In one non-limiting example, injection molding can be employed.

In another instance, photolithography methods can be employed to pattern and form a deformable region between the flow channel and the gate channel. Such an approach may be useful in multilayered structures (e.g., a structure having multiple layers, such as a top substrate, a membrane layer, and a bottom substrate).

In yet another instance, fabrication methods can include in situ formation of the deformation region by using wet chemical or dry chemical methods. In one instance, the method can include the use of two or more reagents, in which a reaction between the reagents form a material for the deformable region. For instance, the reagents can include prepolymers, catalysts, and/or solvents, which can react to form a solid that can serve as the deformable region. In another instance, the method can include the use of one or more reagents, in which the reagent(s) etch away a material of the channel to form a deformable region in the etched region. The deformable region can include any useful material. Non-limiting materials for the deformable region includes an elastomer, a silicon oxide, a thin metal layer (e.g., a thickness from about 1 nm to about 1 mm), a thin polymer layer (e.g., having a thickness from about 1 nm to about 1 mm), and the like, or a combination thereof (e.g., a multilayer including different materials or a patterned layer including different materials).

In a particular instance, the method can include flowing a first reagent through the flow channel and flowing a second reagent through the gate channel, in which the first and second reagents react at a junction (between the flow and gate channels) to form the deformable region. FIG. 4D shows a fluidic network 4200A, in which the gate channel 4225 and the flow channel 4215 are defined within a single substrate 4201, and the channels are substantially parallel to each other. At one region, the flow channel 4215 and the gate channel 4225 intersect to form a junction 4210. At this junction 4210, fluidic communication can occur between the flow and gate channels 4215, 4225. As can also be seen, the channels have respective inlets 4124, 4224 and outlets 4216, 4226. In one example, a deformable region can be formed by flowing a first reagent through the inlet 4124 of the flow channel 4215 and by flowing a second reagent through the inlet 4224 of the gate channel 4225. At the junction 4210, the first and second reagents would meet (e.g., by way of laminar flow) and interact (e.g., react, precipitate, polymerize) to form a deformable region 4250 within a fluidic network 4200B, thereby forming a fluidic transistor (FIG. 4E).

The geometry and characteristic dimension of the fluidic transistor can be defined by the flow channel and the gate channels. For instance, the angle in which the flow and gate channels intersect, the extent of channel overlap, channel width, channel height, etc., can be modified. As seen in FIG. 4F, a length L of the fluidic transistor can be determined by the region of the flow channel 4315 and the gate channel 4325 intersect to provide the junction 4310. FIG. 4F shows a fluidic network 4300, in which the gate channel 4325 and the flow channel 4315 are defined within a single substrate 4301, and the channels are substantially parallel to each other. At one region, the flow channel 4315 and the gate channel 4325 intersect to form a junction 4310. At this junction 4310, fluidic communication can occur between the flow and gate channels 4315, 4325. As can also be seen, the channels have respective inlets 4324, 4324 and outlets 4316, 4326. Such inlets and outlets can be employed to deliver reagent(s) to the junction in order to form the deformable region at the junction.

### Transistor Characteristics

Typically, the transconductance (gₘ) of a fluidic transistor is the rate of change in the volumetric flow rate through the drain of the device with respect to the change in pressure between the gate and source of the device. The output impedance (r₀) of a fluidic transistor is the reciprocal of the rate of change in the volumetric flow through the drain of the device with respect to the change in pressure between the source and drain of the device. The gate-source compliance of the device (C_{gs}) is the rate of change in the volume of fluid displaced by the deflection of the deformable structure with respect to the change in pressure between the gate and source of the device.

One defining feature of an electronic transistor is its ability to amplify a signal (see, e.g., ref. 16). The maximum amplification achievable by an electronic transistor is quantified by its intrinsic gain (A₀), which is the product of its transconductance and its output impedance (see, e.g., ref. 17).

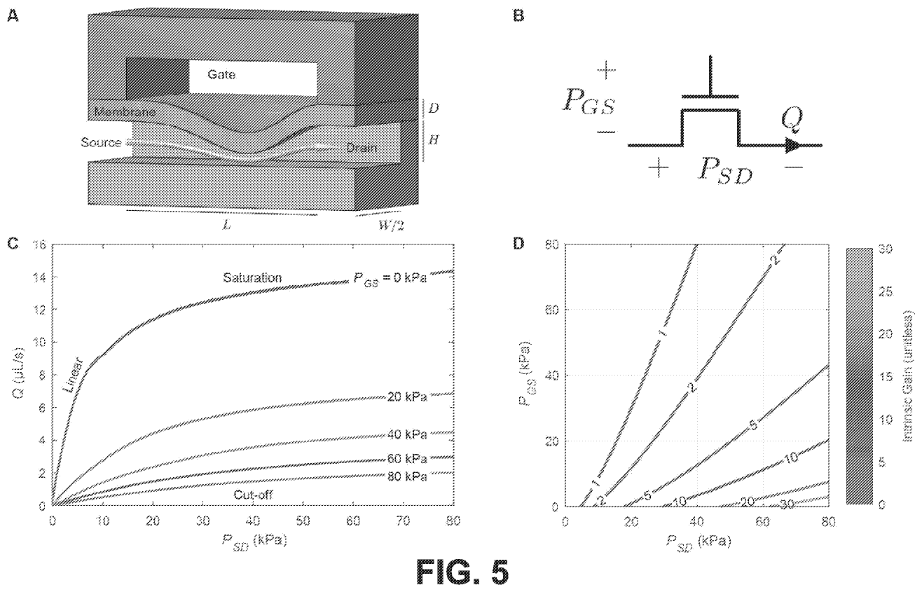

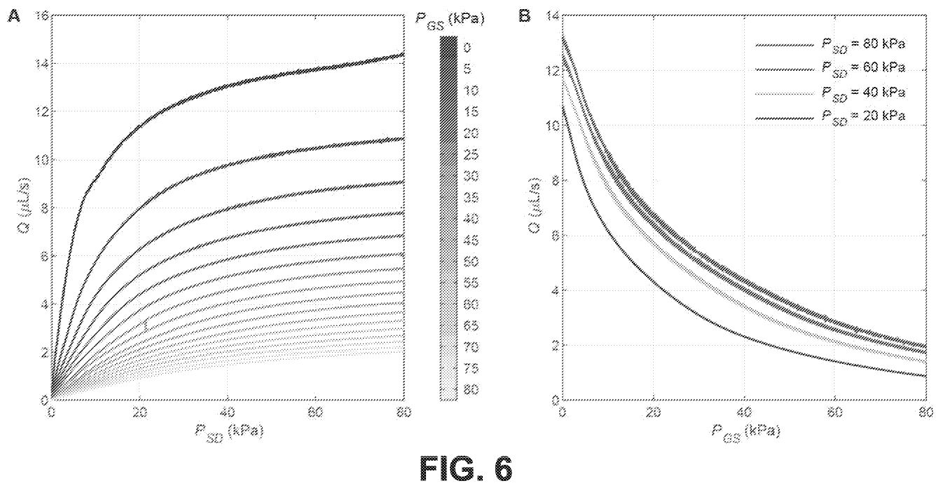

The intrinsic gain of an electronic transistor must be greater than one when amplifying a signal. Similarly, the intrinsic gain of a fluidic transistor can be defined in the same way, as the product of its transconductance and output impedance, and must also be greater than one when amplifying a signal. In one embodiment, a change in pressure of the second fluid in the gate region induces a change in flow rate of the first fluid through the flow region that is larger than the quotient of the change in pressure and the output impedance. In another embodiment of the fluidic transistor, an intrinsic gain of over 20 was achieved (see, e.g., FIG. 5D). Other non-limiting embodiments described here may achieve intrinsic gains exceeding 1000. In yet another non-limiting embodiment, the intrinsic gain of the fluidic transistor or the gain of a fluidic network having the fluidic transistor is greater than one. This property can be determined using pressure sensors to measure pressures across the transistor and flow sensors or particle imaging velocimetry (PIV) techniques to measure the flow through the drain.

Another characteristic of a fluidic transistor, its unity-gain frequency (fₜ), is the maximum frequency at which a sinusoidal input signal can be amplified by the transistor. Typically, fₜ is given as the quotient of its transconductance and its gate-source compliance. This property can be determined using pressure sensors to measure pressures across the transistor and flow sensors or PIV (particle imaging velocimetry) techniques to measure the flow through the drain and the volume displaced at the gate.

### Fluidic Networks

The present disclosure encompasses fluidic networks that can include one or more fluidic transistors. In particular embodiments, the fluidic network includes at least two channels (e.g., a flow channel and a gate channel), in which the channels are in fluidic communication with the flow region and the gate region. In one embodiment, the flow channel is in fluidic communication with the flow region, and the gate channel is in fluidic communication with the gate region.

Two fluidic elements can be a part of the same fluidic network if it is possible to alter the pressure or the flow entering/leaving one element by altering the pressure or the flow entering/leaving another element. In some embodiments, the fluidic network includes one or more fluidic transistors in fluidic communication with one or more fluidic elements.

Fluidic networks may include one or more fluidic loads in addition to fluidic transistors. A fluidic load is a fluidic element with two specified terminals having a monotonic relationship between the pressure applied between the specified terminals and the flow passing into or out of the specified terminals. Examples of fluidic loads include fluidic resistors, fluidic diodes, fluidic transistors, channels, or a fluidic network.

The fluidic network can include a fluidic transistor that is fluidically connected in any useful manner. For example, the fluidic transistor can be configured in a common-source topology, a common-gate topology, or a common-drain topology. In another instance, the fluidic transistor is configured in a combination of two or more topologies including a common-source, common-gate, or common-drain topology. Furthermore, the fluidic transistor can be configured to amplify any useful fluidic signal. For instance, the fluidic transistor can amplify pressure, flow, or both pressure and flow.

In one embodiment, the fluidic transistor is configured in a common-source topology as part of a fluidic network (e.g., for example and without limitation, as in a fluidic amplifier). For example, a fluidic network can include a fluidic transistor having a gate region, a source region, and a drain region. The flow region can include an inlet configured as a source region and an outlet configured as a drain region, in which the first fluid is transported from the source to the drain. Here, a gate region of the fluidic transistor can be configured as an input terminal for an input fluidic signal, and the drain region can be configured as an output terminal to provide an output fluidic signal. In some embodiments, the output fluidic signal is amplified, as compared to the input fluidic signal. In other embodiments, the input fluidic signal is an input pressure signal (e.g., of the second fluid), and the output fluidic signal in an output pressure signal (e.g., of the first fluid). In yet other embodiments, the output pressure signal is amplified, as compared to the input pressure signal. In some embodiments, the fluidic amplifier is configured to provide amplification, such that a small relative change in the pressure of the input fluidic signal produces a large relative change in the pressure of the output fluidic signal.

In any embodiment herein, a source region can be any region that is in fluidic communication with a drain region (which can be any region herein), in which flow of the first fluid is transported from the source region to the drain region. In one instance, the flow region includes an inlet configured as a source region and an outlet configured as a drain region.

In another embodiment, the fluidic transistor is configured in a common-gate topology as part of a fluidic network (e.g., for example and without limitation, as in a fluidic regulator or a fluidic flow-buffer). For example, a fluidic network can include a fluidic transistor having a gate region, a source region and a drain region. The flow region can include an inlet configured as a source region and an outlet configured as a drain region, in which the first fluid is transported from the source to the drain. Here, a source region of the fluidic transistor can be configured as an input terminal for an input fluidic signal, and the drain region can be configured as an output terminal to provide an output fluidic signal. In some embodiments, the input fluidic signal is an input pressure signal (e.g., of the first fluid), and the output fluidic signal is an output pressure signal (e.g., of the first fluid). In yet other embodiments, the fluidic network is configured to provide an output fluidic signal whose flow rate is substantially equal to that of the input fluidic signal but can supply a greater pressure than would be observed if the input fluidic signal was in direct fluidic communication with the output fluidic signal.

In yet another embodiment, a fluidic regulator includes a fluidic load and a fluidic transistor, in which a first terminal of the fluidic load is in fluidic communication with the source region of the fluidic transistor, the drain region of the fluidic transistor is configured as an output terminal, and a second terminal of the fluidic load is in fluidic communication with the gate region of the fluidic transistor and is configured as an input terminal. In some embodiments, the output fluidic signal is regulated, as compared to the input fluidic signal. In other embodiments, the input fluidic signal is an input pressure signal and the output fluidic signal is a flow signal.

In yet another embodiment, the fluidic transistor is configured in a common-drain topology as part of a fluidic network (for example and without limitation, as in a fluidic pressure-buffer or a level-shifter). For example, a fluidic network can include a fluidic transistor having a gate region, a source region and a drain region. The flow region can include an inlet configured as a source region and an outlet configured as a drain region, in which the first fluid is transported from the source to the drain. Here, a gate region of the fluidic transistor can be configured as an input terminal for an input fluidic signal, and the source region can be configured as an output terminal to provide an output fluidic signal. In some embodiments, the input fluidic signal is an input pressure signal (e.g., of the first fluid), and the output fluidic signal is an output pressure signal (e.g., of the second fluid). In yet other embodiments, the fluidic network is configured to provide an output fluidic signal whose pressure is substantially equal to that of the input fluidic signal but can supply a greater flow than would be observed if the input fluidic signal was in direct fluidic communication with the output fluidic signal. For any flow or pressure signal comparisons herein, a substantially equal signal can include a first signal that is within about 20%, 15%, 10%, 8%, 5%, 3%, 2%, 1%, or less of a second signal; or a first signal that is less than about 20%, 15%, 10%, 8%, 5%, 3%, 2%, 10%, or less of a second signal; or a first signal that is more than about 20%, 15%, 10%, 8%, 5%, 3%, 2%, 1%, or less of a second signal. In other embodiments, a substantially equal signal can include a first signal that is +/−20%, +/−15%, +1-10%, +/−8%, +/−5%, +/−3%, +/−2%, +/−1%, or less of a second signal.

In yet another embodiment, a fluidic level-shifter includes a fluidic load and a fluidic transistor, in which a first terminal of the fluidic load is in fluidic communication with the source region of the fluidic transistor, the gate region of the fluidic transistor is configured as an input terminal, and a second terminal of the fluidic load is configured as an output terminal. In some embodiments, the output fluidic signal is level-shifted, as compared to the input fluidic signal. In other embodiments, the input fluidic signal is an input pressure signal and the output fluidic signal is a pressure signal. In yet other embodiments, the input fluidic signal is an input pressure signal and the output fluidic signal is a flow signal. In some embodiments, the output fluidic signal is level-shifted, as compared to the input fluidic signal. In other embodiments, the input fluidic signal is an input pressure signal (e.g., of the second fluid), and the output fluidic signal in an output pressure signal (e.g., of the first fluid). In yet other embodiments, the fluidic level-shifter is configured to provide an output fluidic pressure signal that substantially follows the dynamic component of the input fluidic pressure signal, but the static component of the output fluidic signal is shifted by a known value of pressure. Such a shift can be measured from the center line of the signal (or the 0 Hz component of the signal). The known value of pressure can be selected based on the characteristics of the fluidic load and the characteristics of the transistor.

In one embodiment, the fluidic transistor is configured as a fluidic logic gate that is a fluidic NAND gate. In some embodiments, the fluidic NAND gate includes a plurality of fluidic transistors. In another embodiment, the fluidic NAND gate includes a first fluidic transistor and a second fluidic transistor. In some embodiments, the gate regions of the fluidic transistors are configured as input terminals for a plurality of input fluidic signals. In further embodiments, the drain regions of the plurality of fluidic transistors are in fluidic connection and are configured as an output terminal to provide an output fluidic signal that varies in pressure depending on the pressures of all the input fluidic signals. In other embodiments the output fluidic pressure signal is the result of a logic NAND operation on the input fluidic signals.

In one embodiment, the fluidic transistor is configured as a fluidic logic gate that is a fluidic NOR gate. In some embodiments, the fluidic NOR gate includes a plurality of fluidic transistors. In another embodiment, the fluidic NOR gate includes a first fluidic transistor and a second fluidic transistor. In some embodiments, the gate regions of the fluidic transistors are configured as input terminals for a plurality of input fluidic signals. In further embodiments, wherein the transistors are connected in a series order, such that the drain region of each fluidic transistor in the order is in fluidic communication with the source region of the next fluidic transistor in the order. Furthermore, the drain region of the last fluidic transistor can be configured as an output terminal to provide an output fluidic signal that varies in pressure depending on the pressure of all the input fluidic signals. In other embodiments, the output fluidic pressure signal can be the result of a logical NOR operation on the input fluidic signals.

The fluidic network can include fluidic transistors, as well as other fluidic elements. Non-limiting examples of such fluidic elements can include a fluidic amplifier, a fluidic regulator, a fluidic level-shifter, a fluidic NAND gate, a fluidic load, a fluidic resistor (e.g., a serpentine channel, a narrowed section of a channel (as compared to another section of channel in fluidic communication with this narrowed section), and the like), a fluidic capacitor (e.g., a fluidic structure or a fluidic chamber that stores a fluid, similar to an electrical capacitor that stores charge, and then releases such fluid to provide a fluidic signal), a fluidic inductor, a fluidic diode (e.g., a fluidic structure or a fluidic chamber having internal structural components that provides a uni-directional fluidic signal under certain conditions), a fluidic trap (e.g., a chamber having a plurality of terminals, in which each terminal is in fluidic communication with a channel, at least one input channel provides a particle, cell, or substance to be trapped, at least one output channel transports the particle, cell, or substance out of the trap, and at least one waste channel configured to remove waste, fluid, or other reagents away from the trap), a fluidic filter (e.g., a fluidic channel or a fluidic chamber having filtering structures, such as pillars, weirs, pores, and the like; or a plurality of channels having varying channel dimensions, varying pillar sizes, varying pore sizes, and the like), a fluidic channel, and/or a fluidic chamber.

The fluidic network can include one or more subcircuits, in which at least one subcircuit includes one or more fluidic transistors. In some embodiments, the subcircuit includes a fluidic amplifier, a fluidic regulator, a fluidic level-shifter, a fluidic NAND gate, or any other fluidic element described herein. Furthermore, such a fluidic element can include a fluidic analogue of a range of electronic circuit topologies. Such a fluidic analogue can be designed, analyzed, and modelled as an electronic component, but in which an electronic signal is a fluidic signal.

### Methods of Using a Fluidic Transistor

The present disclosure encompasses methods of using a fluidic transistor. Such methods can provide any result that arises from using a fluidic transistor.

One non-limiting method can include methods of transforming an input fluidic signal by using a fluidic transistor within a fluidic network. Such a method can include flowing a first fluid through the fluidic transistor; and applying an input fluidic signal to a terminal of the transistor (e.g., a source, drain, or gate region), thereby generating an output fluidic signal that is controlled by the input fluidic signal by flow-limitation. In some instances, a gating fluidic signal is an input fluidic signal applied to the gate region.

The input fluidic signal can be applied to the gate region. In one embodiment, the method can include flowing a first fluid through a flow region adjacent to a deformable region configured to induce flow-limitation as the first fluid is transported; and applying an input fluidic signal (e.g., an input pressure signal) to a second fluid located in a gate region adjacent to the deformable region. In particular embodiments, applying an input fluidic signal to the second fluid results in applying that signal to the deformable region. In another instance, the extent of flow-limitation experienced by the first fluid is controlled by the input fluidic signal.

Such configurations can provide, e.g., a common-source topology or a common-drain topology. In one instance, applying the input fluidic signal to the gate region generates an output fluidic signal from the flow of the first fluid. The output fluidic signal can be generated in any useful manner. For example, the output fluidic signal can be generated from the inlet of the flow region or the outlet of the flow region. In another example, the output fluidic signal can be generated by using a fluidic load in fluidic communication with the flow region, such that a pressure difference across the fluidic load is configured to be as the output fluidic signal.

The input fluidic signal can be applied to the flow region. In one embodiment, the method can include applying an input fluidic signal to an inlet of a flow region configured to transport a first fluid, wherein the flow region is adjacent to a deformable region configured to induce flow-limitation as the first fluid is transported; and applying a gating fluidic signal to a second fluid located in a gate region adjacent to the deformable region. In some embodiments, the extent of flow-limitation experienced by the first fluid is controlled by the input fluidic pressure signal and the gating fluidic signal. In other embodiments, applying the input fluidic pressure signal and the gating fluidic signal generates an output fluidic signal from the outlet of the flow region. In yet other embodiments, the output fluidic signal is from a pressure difference across the flow region. In some embodiments, the gating fluidic signal is a substantially non-varying pressure signal. Such configurations can provide, e.g., a common-gate topology. For any flow or pressure signal comparisons herein, a substantially non-varying signal can include a signal that varies within about 20%, 15%, 10%, 8%, 5%, 3%, 2%, 1%, or less of a desired signal; or a signal that is less than about 20%, 15%, 10%, 8%, 5%, 3%, 2%, 10%, or less of a desired signal; or a signal that is more than about 20%, 15%, 10%, 8%, 5%, 3%, 2%, 1%, or less of a desired signal. In other embodiments, a substantially non-varying signal can include a signal that is +/−20%, +/−15%, +/10%, +/−8%, +/−5%, +/−3%, +/−2%, +/−1%, or less of a desired signal.

Another non-limiting method can include methods of controlling flow within a fluidic network. The method can include, e.g., deforming a deformable region of a fluidic transistor, thereby inducing flow-limitation of a first fluid being transported within a flow region. In one embodiment, such deforming can including applying a pressure difference between various regions of the transistor (e.g., between the source and drain, between the gate and source, or between the gate and drain). In one embodiment, deforming can include applying a first pressure (P_{SD}) between a source and a drain; and applying a second pressure (P_{GS}) between the gate region and the source, in which P_{SD} and P_{GS} can be applied in any order or simultaneously.

### Methods of Manufacturing

The present disclosure encompasses methods of manufacturing a fluidic transistor. There are a range of manufacturing technologies that may be used to fabricate the fluidic transistors and fluidic networks herein.

One non-limiting method can include providing a deformable region disposed between a flow region and a gate region, in which the deformable region is configured to induce employ flow-limitation as a first fluid is transported within the flow region. The deformation region can be formed of any useful material. Non-limiting materials includes an elastomer, a silicon oxide, a thin metal layer, a thin polymer layer, and the like.

Such methods can include the formation of channels. In one embodiment, the method can include forming a flow channel, in which the flow region is disposed therein; and forming a gate channel in which a gate region is disposed herein, in which these channels can be formed simultaneously or sequentially in any order. The flow and gate channels can be disposed in a single substrate or in different substrates. The single substrate or different substrates can include any useful material, e.g., glass, plastic, a semiconductor, a metal, an elastomer, or a combination thereof.

The flow channels and gate channels can include inlets and outlets. Such inlets and outlets can, optionally, be provided with ports for access and for connection with containers having one or more fluids.

The substrate containing the flow region and the deformable region may be fabricated together or separately and then bonded. One or a combination of several technologies may be used for fabrication. In one embodiment, soft-lithography methods are used to fabricate the substrate for the flow region from elastomer. In an alternative embodiment, additive manufacturing techniques are used to fabricate the substrate for the flow region from plastic. In an alternative embodiment, photolithography techniques are used to etch the flow channels out of silicon. In an alternative embodiment, photolithography techniques are used to etch the flow channels out of glass. In an alternative embodiment, laser micromachining techniques are used to ablate the flow channels out of glass, silicon, or metal. In an alternative embodiment, injection molding or hot-embossing techniques are used to form the flow channels out of plastic. Yet other useful methods include molecular beam epitaxy (MBE), hydride vapor phase epitaxy (HVPE), physical vapor deposition (PVD), chemical vapor deposition (CVD), atomic layer deposition (ALD), a metalorganic chemical vapor deposition (MOCVD) process, sputtering, spin-on coating, or another suitable formation method.

The deformable region can be formed in any useful manner. In an alternative embodiment, soft-lithography techniques are used to manufacture the deformable region from an elastomer. In an alternative embodiment, photolithography techniques are used to generate the deformable region from silicon oxide. In an alternative embodiment, photolithography techniques are used to deposit the deformable region as a thin layer of metal.

The deformable region can be provided as a deformable layer. In one instance, a method can include providing a deformable layer disposed between the flow channel and the gate channel. The deformable layer can include any useful material, e.g., an elastomer, a silicon oxide, a thin metal layer, a thin polymer layer, and the like.

The deformable region can be formed in situ. In one instance, the flow channel and the gate channel can intersect to form a junction. The method can include separate steps to provide the deformable region. Such steps can include flowing a first reagent through the flow channel; and flowing a second reagent through the gate channel, in which the first and second reagents react at the junction to form the deformable region. Flowing of the first and second reagents can occur simultaneously or sequentially in any order.

The fluidic transistors and fluidic networks may be fabricated from any useful material and employing any useful methodology. For instance, the substrate can include, e.g., quartz, glass, polycarbonate, fused-silica, poly(dimethyl siloxane), a polymer, a metal, a semiconductor (e.g., silicon, silicon oxide, silicon nitride, etc.), or a transparent substrate, as well as composites and multi-layered, laminated, or bonded forms thereof. Exemplary methods of fabrication include rapid prototyping, microfabrication (e.g., by casting, injection molding, compression molding, embossing, ablation, thin-film deposition, and/or Computer Numerically Controlled (CNC) micromachining), photolithography, etching techniques (e.g., wet chemical etching, reactive ion etching, inductively coupled plasma deep silicon etching, laser ablation, or air abrasion techniques), methods for integrating these structures into high-throughput analysis equipment (e.g., integration with a microplate reader or a control instrument, such as a computer), and methods for providing ports or inlets (e.g., by piercing, drilling, ablating, or laser cutting).

### Fluidic Features

The flow regions, flow channels, gate regions, and gate channels herein can have any useful fluidic features. For example, a channel may have an inlet or an outlet. In one instance, the outlet of a channel is a closed end. In another example, a region (e.g., a flow region or a gate region) may also be characterized by an inlet and an outlet, in which such inlets and outlets can be in fluidic communication with a channel or be a portion of the channel. A channel may be enclosed within a substrate and include one or more ports (e.g., inlets and/or outlets) in fluidic communication with one or more ends of the channel.

The regions and channels herein can be characterized by a cross-section. The shape of such a cross-section can vary within a specific channel or region, between different channels or regions, and the like. Non-limiting cross-sections include those that are substantially square; substantially quadrilateral (e.g., rectangular, parallelogram, rhomboid, kite, trapezoid); substantially circular, oval, semi-circular, and the like; substantially curved, triangular, hexagonal, or any other suitable shape. In some embodiments, the region or channel may alternatively have a combination of one or more types or shapes of cross-sections. For example, in some embodiments, a channel can include a portion that is substantially rectangular in cross-section and a portion that is substantially circular or oval in cross-section.

Various fluidic elements (e.g., regions or channels) can be interconnected by a valve, a port, and/or a (further) channel that can optionally include a valve in its fluidic path. The fluidic elements can have any useful dimension, geometry, and/or configuration. For instance, the fluidic elements can have any useful cross-sectional dimension, such as a length, depth, width, diameter, and/or major axis of from about 10 nm to about 1 mm. Furthermore, a region can be configured as a chamber, a well, or a channel connected to one or more other regions, chambers, wells, or channels.

A fluidic network can include any useful type and number of structures (e.g., channels, regions, other fluidic elements, etc.) to perform the desired multiplexed reactions and/or to establish the desired fluidic pathway. In a fluidic network, one or more fluidic transistors can be used to control flow and transport through the regions or channels. One or more ports to provide fluidic access to the fluidic network. In particular, such ports can be in fluidic communication with a sample reservoir or a reagent reservoir in a manifold in order to deliver sample portions and reagents to the fluidic network (e.g., by way of fluidic connections provided by one or more fluidic elements). Each port may be useful as an inlet, an outlet, or a combination of inlets and outlets depending on the fluidic pathway being established on-chip.

Any useful test sample can be analyzed. Exemplary test samples can include one or more cells, including rare cells (e.g., primary cells, stem cells, cancer cells, etc.); a biopsy sample; a cell; a tissue; a fluid; a swab; a biological sample (e.g., blood, serum, plasma, saliva, etc.); an environmental sample; a microorganism; a microbe; a virus; a bacterium; a fungus; a parasite; a helminth; a protozoon; a nucleic acid (e.g., oligonucleotides, polynucleotides, nucleotides, nucleosides, molecules of DNA, or molecules of RNA, including a chromosome, a plasmid, a viral genome, a primer, or a gene); a protein (e.g., a glycoprotein, a metalloprotein, an enzyme, a prion, a kinase, a membrane protein, a receptor, or an immunoglobulin); a metabolite; a cytokine; a cofactor; a factor (e.g., a transcription factor); a sugar or saccharide (e.g., including polysaccharides and monosaccharides); a lipid; a lipopolysaccharide; a salt; an ion; and/or a particle (e.g., cells, including macrophage cells, and beads, including beads having cells or other biological materials attached to the beads).

In some embodiments, a sample is capable of flowing through the microchannel. The sample can include one or more of a fluid suspension or any sample that can be put into the form of a fluid suspension, and that can be driven through the microchannel. Particles (e.g., cells) suspended within a sample can have any useful size. For example, particles can have a hydrodynamic size that is between 1 μm and 100 μm. The particle size is limited only by channel geometry; accordingly, particles that are larger and smaller than the above-described particles and can be transported through the channel can be used.

A fluid can include any type of fluid, e.g., water, a buffer, a cell culture medium. The particles dispersed in the fluid can include biological particles, e.g., mammalian cells (e.g., human cells) such as immune cells (e.g., T cells), stem cells, tumor cells, red blood cells, white blood cells, non-mammalian cells, or other types of biological particles that occur either naturally or are introduced artificially into the fluid. The particles dispersed in the fluid can also include non-biological or synthetic particles, e.g., lipid nanoparticles or lipid vesicles.

The fluidic transistor(s) and fluidic networks herein can, optionally, be employed within a system. A system can optionally include a controller configured to control or regulate an input fluidic signal (e.g., pressure, flow, and the like). In some embodiments, the system can include one or more sensors configured to detect a change in a flow rate and/or a change in a pressure of the system. The system can optionally include one or more regulated pressure lines, which is in fluid connection with an inlet of the fluidic network.

### ADDITIONAL DISCLOSURES

The electronic transistor enabled revolutionary advances in the control and processing of electronic signals. Here, we disclose a fluidic analogue to the electronic transistor, aiming to enable advances in the control and processing of small volumes of fluids including cells, chemicals, or droplets. These fluidic transistors may be connected in microfluidic circuits to perform complex manipulations of fluids for advanced chemical or biological platforms.

The field of microfluidics utilizes circuits of small fluid-filled channels to perform fluidic manipulations on cells, drugs, and chemicals. Many simple microfluidic circuits have been used in medical and research applications. Unfortunately, advanced circuits are limited in their functionality by the lack of a fluidic element analogous to the electronic transistor. Without transistor-based circuitry, complex flow control on microfluidic chips are generally relegated to external electronic systems, employing a large number of individual wires or tubes to valves embedded in the microfluidic chips. These systems are typically not modular, difficult to scale, and are practically limited in the complexity of fluidic operations they can perform. With microfluidic transistor-based circuitry, all these complex fluidic operations may be performed on the chip itself, without cumbersome external control systems. Furthermore, as the demand for complex fluid handling systems grows, a wide variety of advanced fluidic operations now would now become possible to implement for novel genomics, biology, and chemistry platforms.

Prior work on microfluidic flow control has resulted in three-terminal fluidic elements that could switch flows entirely on or off, but could not perform analog amplification (the defining characteristic of the transistor). As a result, those devices were unable to function like a fluidic transistor and could not be used to implement the vast repertoire of transistor-based circuits for advanced fluidic applications.

We have fabricated and tested numerous fluidic transistors. In particular embodiments, the tested devices display the desired transistor characteristics and were capable of amplification in a circuit. In some instances, the tested fluidic transistors included two carefully designed fluidic channels molded in plastic, separated by an elastic membrane.

We have additionally explored various fabrication geometries to show that a wide range of transistor characteristics may be achieved with small modifications to the fabricated geometry. This enables a circuit designer to select the transistor geometry that best fits the required characteristics for the circuit being designed.

We have also successfully utilized the fluidic transistor in a number of classic circuit building blocks including a differential amplifier, a flow regulator, a level-shifter, a NAND gate, and a SR-latch (flip-flop). These classic circuit building blocks are present in various analog circuit designs and demonstrate the broad applicability of the element to build more complex fluidic circuits.

Finally, we have refined the fabrication process in an attempt to make these fluidic transistors as simple, cost-effective, and scalable to manufacture as possible. The small footprint (0.25 mm²) allows thousands to be fabricated on a single microscope slide. They can be fabricated in batches using basic soft-lithography processes but other manufacturing processes may be employed. No manufacturing operations are required to be performed individually on each transistor so the process may be easily scaled, similar to lithography processes for electronic transistors. The cost of materials per fluidic transistor is currently much less than a cent.

In one non-limiting example, the fluidic element includes fluid-filled channels and an elastic membrane, such that the flow of fluid through a channel may be regulated by applying a pressure to the elastic membrane (see, e.g., FIG. 5). Under particular geometric configurations that we have identified, this element is capable of amplifying a pressure or flow signal in a fluidic circuit, analogous to how a transistor is capable of amplifying a voltage or current signal in an electrical circuit.

With this implementation of a fluidic transistor, a large number of pre-existing electrical circuit designs may be directly synthesized, simulated, and fabricated as fluidic circuits. The extensive design and analysis techniques from the well-established field of electrical circuit design may also be directly leveraged to build advanced transistor-based fluidic circuits.

Just as there are a wide range of electronic transistors with differing characteristics that a designer may select from, we have identified a wide range of geometries for our fluidic transistors that lead to differing characteristics. A designer may thus select the optimal geometry to match their specific circuit requirements.

Fluidic transistors may be used to realize important circuit building blocks in the fluidic domain (including, e.g., amplifiers, oscillators, flip-flops, diodes, regulators, and logic gates) to perform advanced, modular fluidic operations and processing. Using these building blocks, we intend to enable the one-to-one translation and implementation of the electronic circuit design repertoire. These fluidic operations and processes may be applied in complex fluidic circuitry to directly control and manipulate cells, drugs, media, chemicals, or other fluids for advanced genomics, molecular biology, cellular biology, and chemistry applications.

One attribute of this technology for commercial interests is its ease of implementation. We have attempted to bring this technology to the point where the manufacturing of these fluidic transistor circuits is scalable and straightforward with minimal additional development needed. Complex circuits with hundreds of these transistors may be injection molded at very low part cost. The designing of the transistor circuits themselves may also be done with minimal additional development, since the fluidic designs may be translated from existing electronic circuit designs.

We have identified two non-limiting commercial applications for the technology below.

### Perfect Droplet Encapsulation

Single cell analysis, including single cell genomics and transcriptomics, can depend on droplet formation. A microfluidic chip can be used to encapsulate a single cell with a single bead in a fluidic droplet. Yet, encapsulation can be unsuccessful for various reasons. For instance, a particular fraction of the beads may be inefficiently or unsuccessfully paired with a cell. In another instance, the cells themselves can be ineffectively encapsulated, which can be challenging in samples that typically contain very few of the target cells (such as, e.g., circulating tumor cells).

A transistor-based fluidic circuit (or fluidic network) utilizing our technology could enable deterministic droplet encapsulation, where the fluidic circuitry “senses” the individual cells/beads flowing into the chip, and encapsulates them together without any wasted cells/beads. Not only would this reduce the large bead cost of existing single-cell platforms, but it would also enable these platforms to run on very small tissue samples since few cells are wasted. Finally, our transistor-based method of encapsulation can be easily scaled to encapsulate multiple cells and beads in a droplet, enabling more complex assays, such as cell-cell interaction assays. Importantly, our technology would accomplish this without any additional optics or electronics, since all of the “processing” is done within the molded fluidic circuitry on the plastic chip itself.

### Ultra-High Throughput Drug Screening

One of the initial steps in the pharmaceutical drug discovery pipeline is high throughput screening, where fluid-handling robotics are used to test vast compound libraries against biological targets to identify novel drug candidates for further investigation. For example, in a high throughput cancer screening run, a library of a few thousand small molecules may be screened against a few hundred cancer cell lines over the course of several weeks. This is accomplished by mixing a small sample from each cancer cell line with a small sample of each target molecule at various concentrations using a robotic fluid handling system and a microwell plate. Fluorescent probes are typically used to analyze the millions of drug-cell-dose combinations to identify promising drug candidates for the next step in the discovery pipeline. The more combinations of drugs and cells can be tested; the more potential drug candidates may be identified. Recent advances in robotic fluid dispensers have allowed ultra-high throughput drug screening facilities to process over 100,000 combinations per day. Unsurprisingly, these state-of-the-art facilities require millions in capital, specialized maintenance, and have high operating costs.

Our fluidic transistor-based circuitry may be used to replace part of the fluid-handling systems in these facilities to improve the speed, cost, footprint, and reagent efficiency. For example, a fluidic circuit may be designed to dispense every combination of a number of drugs with a number of cell lines at a range of concentrations sequentially using a single microfluidic chip with the metering circuitry molded on the chip itself for high speed. Simulations indicate that our fluid transistors have a switching speed on the order of 100 Hz, which corresponds to a screening throughput of over a million combinations per day on a single plastic chip without any robotics or optics. When compared to conventional ultra-high throughput robotic systems, the tiny footprint and high speed of each chip may allow orders-of-magnitude improvements in parallelization, increased throughput, reduced costs, and reduced reagent wastes. This improved scalability and throughput will be increasingly important as drug discovery pipelines begin to implement multi-drug cocktail screening for cancer therapies.

### Other Potential General Applications

Yet other potential applications include the following:
Genomics
   Cell-cell co-encapsulation for co-culture and interaction assays
   Single cell dispensing for well-based and microarray platforms
Biology
   Sized-based cell-sorting
   Multi-step synthetic biology microreactors
   Powering point-of-care assays
Chemistry
   Combinatoric/sequential oligonucleotide synthesis
   Microreactors for on-demand drug synthesis
   Combinatorial chemistry for drug library synthesis
General fluid handling
   Multi-particle co-encapsulation in droplets (e.g., a droplet including a plurality of particle types that can be co-encapsulated, such as a droplet including cells and beads)
   Flow/pressure regulators for point-of-care microfluidics
   Automatic declogging of liquid filters
   Rapid micro-volume liquid dispensing
   Flow/pressure sensors for industrial applications
   Vacuum chucks for industrial applications
   Fluidic computers

### EXAMPLES

### Example 1: A Microfluidic Transistor

Through its defining ability to amplify electrical signals (see, e.g., ref. 1), the transistor quickly became the key component for thousands of electronic designs including amplifiers, logic, memory, and timers. It allowed electrical currents to control each other in a scalable fashion, enabling a single chip to perform highly complex manipulations of current.

The field of microfluidics uses networks of channels to control the movement of small volumes of fluid, typically cells, droplets, or chemicals (see, e.g., ref. ii). This complex fluid control has enabled advances in diagnostics, molecular biology, synthetic chemistry, and tissue engineering. Microfluidic circuits often behave analogously to electronic circuits, where pressure corresponds to voltage and flow corresponds to current. These chips typically employ fluidic elements analogous to electronic elements, such as resistors, capacitors, and diodes.

Unfortunately, microfluidics suffers from the lack of an element equivalent to the electronic transistor. Without on-chip transistor-based feedback, complex flow control on microfluidic circuits are generally relegated to external electronic or pneumatic systems, employing a large number of wires or tubes to valves embedded in the microfluidic chips. These systems are typically not modular, difficult to scale, and are limited in the complexity of fluidic operations they can perform. With microfluidic transistor-based circuitry, all these complex fluidic operations may be performed on the chip itself, without cumbersome external control systems. Furthermore, as the demand for complex fluid handling systems grows, a wide variety of advanced fluidic operations now would now become possible to implement for novel genomics, biology, and chemistry platforms.

Just as the electronic transistor enabled scalable, complex, and self-contained control of electrical currents, a microfluidic analogue to the transistor could enable the same type of manipulations and logic to be performed on small volumes of fluid. This flow control could be used to perform complex fluidic operations on droplets, chemicals, or cells for advanced chemical or biological platforms. These fluidic transistors may be connected in microfluidic circuits to perform complex manipulations of fluids for advanced chemical or biological platforms.

Prior work on microfluidic flow control has resulted in three-terminal fluidic elements that could switch flows entirely on or off, but could not perform analog amplification (the defining characteristic of the transistor). Prior work on developing microfluidic transistors has resulted in devices that could switch flows entirely on or off, but were unable to amplify analog fluidic signals (see, e.g., ref. iii). This ability is needed for true replication of the transistor and is the essential feature that differentiates it from a relay element. Without analog amplification, it is not possible to create feedback loops that are fundamental to modern analog circuit designs and necessary for complex, scalable flow control (see, e.g., ref. iv).

Here, we describe the first elastomeric microfluidic element with characteristics completely analogous to the classical electronic transistor. It is capable of replicating all the operation regimes of the Field Effect Transistor (FET) including saturation, enabling the direct microfluidic translation of the classical electronic design repertoire (including amplifiers, logic, memory, and timers) for fluidic operations on droplets, chemicals, and cells.

Additionally, this microfluidic transistor has designable properties across a wide range of values and may be manufactured entirely from elastomer using basic soft-lithography techniques.

### Example 2: A Microfluidic Transistor Enabled by Flow-Limitation

There is a critical need in microfluidics to control reagents, droplets, and particles with the precision, modularity, and scalability of electronic circuits. We address this problem by developing a microfluidic analogue to the electronic transistor, based on the fluid phenomenon of flow-limitation. We first show that this microfluidic transistor replicates the key behaviors of the electronic transistor, including amplification. We then used this transistor to directly translate a variety of fundamental electronic circuit designs into the fluidic domain. Finally, we used microfluidic transistor-based circuitry to directly manipulate matter by demonstrating a “smart” particle dispenser, capable of sensing and dispensing individual suspended particles in an automated fashion. Microfluidic transistor chips are trivial to fabricate, scalable, and can be used to perform complex fluidic operations for the next generation of chemical and biological platforms.

The field of microfluidics uses networks of channels to control the flow of small volumes of fluid (see, e.g., ref. 1). This flow control has enabled advances in molecular biology (see, e.g., ref. 2-4), synthetic chemistry (see, e.g., ref. 5, 6), diagnostics (see, e.g., ref. 7, 8), and tissue engineering (see, e.g., ref. 9). Unfortunately, as the precision and complexity requirements for these microfluidic chips grow, many platforms are forced to relegate the problem of flow control to bulky, computer-controlled electromechanical or pneumatic valves (see, e.g., ref. 10-14). These external systems can be difficult to implement in practice, are challenging to scale, and limit the complexity of fluidic operations that can be performed (see, e.g., ref. 14, 15). There has long been a critical need in the field to manipulate fluids and suspended matter with the precision, modularity, and scalability of electronic circuits (see, e.g., ref. 14, 22, and 33). Just as the electronic transistor enabled unprecedented advances in the control of electricity on an electronic chip, a microfluidic analogue to the transistor could enable similar improvements in the complex, scalable control of fluids, reagents, single cells, and droplets on an autonomous microfluidic chip.

Prior work on microfluidic flow control has largely focused on the creation of miniature valves (see, e.g., ref. 11, 14). While the valves in these systems are capable of switching flows on or off in fluidic circuits, they do not replicate the saturation behavior of the transistor, and cannot amplify an analog signal—the defining feature of a transistor (see, e.g., ref. 16). Without this characteristic saturation behavior, microfluidic valves cannot be used to perform analog signal processing and limit the potential of applying modular, complex circuit designs from electronics towards the control of fluids.

Here, we describe a microfluidic element with pressure-flow characteristics completely analogous to the voltage-current characteristics of the electronic transistor. We exploit the fluidic phenomenon of flow-limitation to develop a microfluidic element with flow-pressure characteristics completely analogous to the current-voltage characteristics of the electronic transistor. This microfluidic transistor successfully replicated all of the key operating regimes of the electronic transistor (linear, cut-off, and saturation) but in the fluidic domain.

After characterizing the microfluidic transistor, we were able to directly translate a variety of fundamental electronic circuit designs into the fluidic domain. In particular, we demonstrate microfluidic analogues for several classic electronic building blocks, including the amplifier, regulator, level shifter, logic (NAND) gate, and SR-latch. These circuit blocks enable complex signal processing on-chip without external controllers.

Finally, to showcase the microfluidic transistor's ability to directly manipulate particles suspended in fluids, we demonstrate a “smart” particle dispenser. Using only microfluidic signal processing, this dispenser is capable of detecting a single particle entering a fluidic trap and releasing it when triggered by a pressure signal from other microfluidic circuitry. We integrated this dispenser along with several other microfluidic transistor-based circuit blocks into a self-contained system that automatically performs deterministic single-particle ordering and concentration without any external optics or computers. Taken together, the microfluidic circuit was employed to sense single suspended particles, perform liquid signal processing, and accordingly control the movement of said particles in a purely fluidic system without electronics. By leveraging the vast repertoire of electronic circuit design, microfluidic transistor-based circuits are easy to integrate at scale, eliminate the need for external flow control, and enable uniquely complex liquid signal processing and single-particle manipulation for the next generation of chemical, biological, and clinical platforms. Additional details follow.

### Example 3: Non-Limiting Example of a Microfluidic Transistor

The microfluidic transistor includes two crossed channels of fluid separated by a deformable membrane (FIG. 5A) and is fabricated entirely from elastomer using standard soft-lithography techniques (see Example 8). It is represented schematically in FIG. 5B, where the flow and pressures relevant to its function are also labelled. When a pressure difference P_{SD} is applied between the source and drain terminals, the membrane between the crossed channels deforms itself. With carefully chosen channel geometry, this self-deformation limits the volumetric flow Q passing through the drain and can be modulated by the pressure P_{GS} between the gate and source terminals. This behavior is analogous to that of the electronic field effect transistor (FET), where applying a voltage to the gate modulates the saturation current flowing through the drain.

The microfluidic transistor is characterized in a fashion analogous to that of the electronic p-channel junction FET. FIG. 5C provides the characteristic curves for a microfluidic transistor with dimensions provided in Table 1.

TABLE 1
Circuit component details

| Component | Value | Sizing Details | |
|---|---|---|---|
| Transistor | — | Length = | 500 μm, |
| | | Width = | 500 μm, |
| | | Height = | 55 μm |

Volumetric flow Q is recorded, while P_{SD} is swept across a range of pressures and P_{GS} is held at fixed values, resulting in the fluidic version of the classic transistor characteristic curves. For visual clarity, a subset of the measured characteristic curves is plotted in FIG. 5C, and the complete set of curves for all measured values of P_{GS} is provided in FIG. 6A. Additional transconductance characterization of the microfluidic transistor is provided in FIG. 6B.

A defining characteristic for any transistor is its intrinsic gain, a dimensionless measure of the maximum analog amplification achievable for a given set of potentials applied across the source, gate, and drain (see, e.g., ref. 17). Crucially, for a microfluidic element to amplify like a transistor, there must be a practically achievable range of values for P_{SD} and P_{GS} where the intrinsic gain is greater than one (see Example 4, herein). FIG. 5D shows a contour plot of the intrinsic gain as a function of applied P_{GS} and P_{SD}, computed using the characterization data of FIG. 6A. The contour plot reveals a large operating region where the intrinsic gain is much greater than one, indicating that this microfluidic element exhibits true transistor behavior and is capable of greatly amplifying analog signals at a wide range of applied operating pressures.

Significantly, the microfluidic transistors were able to achieve high intrinsic gains by exploiting the fluidic phenomenon of flow-limitation. This phenomenon is observed in certain confined flows through tubes with deformable boundaries, where increasing the pressure drop across the tube beyond a threshold does not substantially increase the flow rate through the tube (see, e.g., ref. 18, 19). The flow-limitation phenomenon occurs in systems where the dimensionless Shapiro number is greater than one (see, e.g., ref. 20). For the microfluidic channels considered here, the Shapiro number S is given as follows (see derivation in Example 5 herein):

$$S = {Q ( \frac{{A}^{3}}{ρ} \frac{{π}^{4} {ED}^{3}}{6 {W}^{5} ( 1 - {ν}^{2} )} )}^{- \frac{1}{2}} , \qquad [ 2 ]$$

where Q is the flow rate, ρ is the fluid density, A is the channel cross-sectional area, W is the channel width, D is the membrane thickness, E is the membrane Young's modulus, and v is the membrane Poisson ratio. Using the above equation (valid when P_{GS}=0) and the measured data from FIG. 5C, the pressure-flow characteristic of the transistor is observed to diverge from the linear Poiseuille behavior when the Shapiro number exceeds one and enters flow-limitation (FIG. 7). This flow-limitation phenomenon in the “Saturation” region (FIG. 5C) is directly responsible for the high intrinsic gain of these devices and is the fundamental mechanism that allows these microfluidic transistors to perform amplification.

### Example 4: Calculation of Intrinsic Gain

Amplification is the defining characteristic of a transistor (see, e.g., ref. 16). While intrinsic gain was originally defined in the context of electronic transistors in terms of voltage and current (see, e.g., ref. 17), we may follow an analogous derivation to define the intrinsic gain for a microfluidic transistor in terms of pressure and flow. For a microfluidic transistor where the flow Q is a function of the pressures P_{SD} and P_{GS} applied across its terminals, the transconductance gₘ is given by:

$${g}_{m} = \frac{\partial Q}{\partial {P}_{G S}} \qquad [ 3.1 ]$$

And the output impedance r₀ is given by:

$${r}_{0} = {( \frac{\partial Q}{\partial {P}_{SD}} )}^{- 1} \qquad [ 3.2 ]$$

Then, the dimensionless intrinsic gain A₀ is given by:

$${A}_{0} = \vert {g}_{m} {r}_{0} \vert = \vert \frac{\partial Q}{\partial {P}_{GS}} {( \frac{\partial Q}{\partial {P}_{SD}} )}^{- 1} \vert \qquad [ 3.3 ]$$

Note that this is analogous to the formula used in electronics for field-effect transistors, substituting pressure and flow for voltage and current (see, e.g., ref. 17).

### Example 5: Shapiro Number for Rectangular Channels

In his seminal work describing flow-limitation, Ascher Shapiro mathematically modeled the behavior of an internal incompressible Newtonian fluid flow through a thin-walled deformable tube (see, e.g., ref. 18). For this system, Shapiro defined a “characteristic wave propagation speed” c by the following:

$${c}^{2} = \frac{A}{ρ} \frac{d {p}_{t}}{dA} , \qquad [ 4.1 ]$$

where A is a characteristic cross-sectional area of the tube, and ρ is the fluid density. The term dpₜ/dA couples structural deformation of the tube to the fluid flow. In previous studies, this term has been deduced based on the “tube law” for the system, which is the relationship between the cross-sectional area of the tube and the transmural pressure p, across its walls. Typically, if the internal pressure of the tube is held constant, increasing the external pressure will cause the tube to deform and cause its cross-sectional area to drop.

While the empirically derived tube law relationship was originally used to describe the deformation of thin-walled cylindrical tubes, here we consider the deformation of a square piece of thin membrane over a rectangular channel (FIG. 5A). Under the condition where P_{GS}<<P_{SD}, the hydraulic compliance of this membrane-channel fluidic system can be derived by plate theory as follows (see, e.g., ref. 25):

$$\frac{{dp}_{t}}{dV} = \frac{{π}^{4} {ED}^{3}}{6 {W}^{6} ( 1 - {ν}^{2} )} , \qquad [ 4.2 ]$$

where V is the volume of fluid in the channel under the membrane, W is the characteristic length scale of the square membrane, D is the membrane thickness, E is the Young's modulus of the membrane material, and v is the Poisson ratio of the membrane material. Dividing both sides by the length of the square membrane, we obtain the following characteristic “tube law” for a channel with a deformable square membrane:

$$\frac{d {p}_{t}}{dA} = \frac{{π}^{4} E {D}^{3}}{6 {W}^{5} ( 1 - {ν}^{2} )} . \qquad [ 4.3 ]$$

Substituting this “tube law” into Eq. [2], we obtain the following expression for the characteristic wave speed c:

$${c}^{2} = \frac{A}{ρ} \frac{{π}^{4} {ED}^{3}}{6 {W}^{5} ( 1 - {ν}^{2} )} . \qquad [ 4.4 ]$$

The Shapiro number S for this system is then simply the ratio of the characteristic fluid velocity to the characteristic wave speed of the channel. In terms of the flow rate Q, this is given as follows:

$$S = \frac{Q}{Ac} = {Q ( \frac{{A}^{3}}{ρ} \frac{{π}^{4} {ED}^{3}}{6 {W}^{5} ( 1 - {ν}^{2} )} )}^{- \frac{1}{2}} . \qquad [ 4.5 ]$$

For the microfluidic transistor characterized in FIG. 5C, the channel width W is 500 μm, the characteristic cross-sectional area A is 0.0275 mm², the membrane thickness D is 20 μm, the membrane Poisson's ratio v is 0.5 (see, e.g., see, e.g., ref. 29), the Young's modulus E is 550 kPa (see, e.g., ref. 30), and the fluid density ρ is 1.01 g/mL (see, e.g., ref. 31). We may then use the characteristic curve measurements to compute the Shapiro number directly from the measured flow rate (FIG. 7). Note that in this preliminary analysis we only consider the curve where P_{GS}=0, which is the case analyzed by Shapiro.

The Shapiro number delineates a critical transition in the behavior of the membrane-channel system (FIG. 7). When the Shapiro number is much less than one, the deformation of the membrane is not expected to significantly restrict flow, and the channel exhibits pressure-flow relationships as predicted by the Poiseuille equation. When the Shapiro number is greater than one, the deformation of the membrane significantly restricts flow, and the phenomenon of flow-limitation takes place (see, e.g., ref. 20).

### Example 6: Fluidic Networks Including Fluidic Transistors

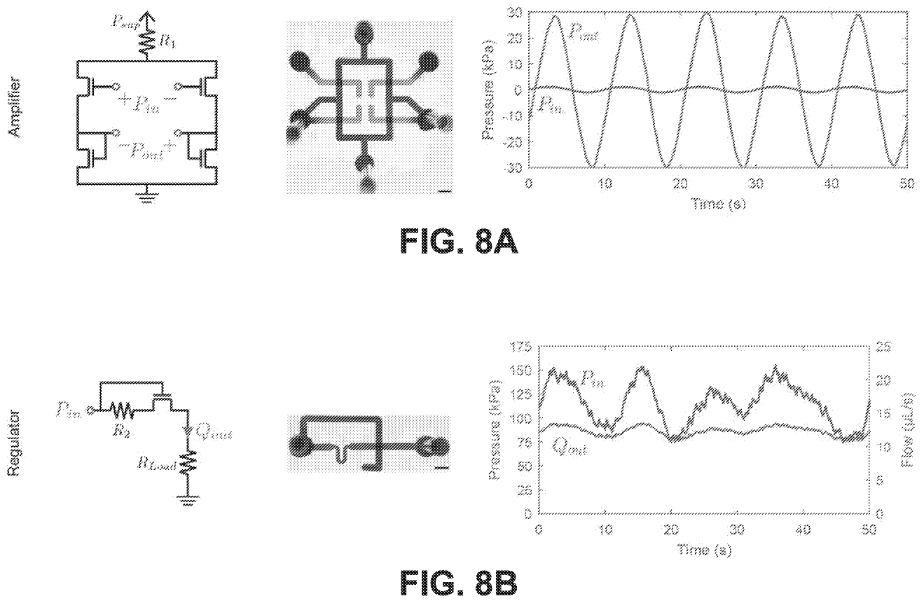

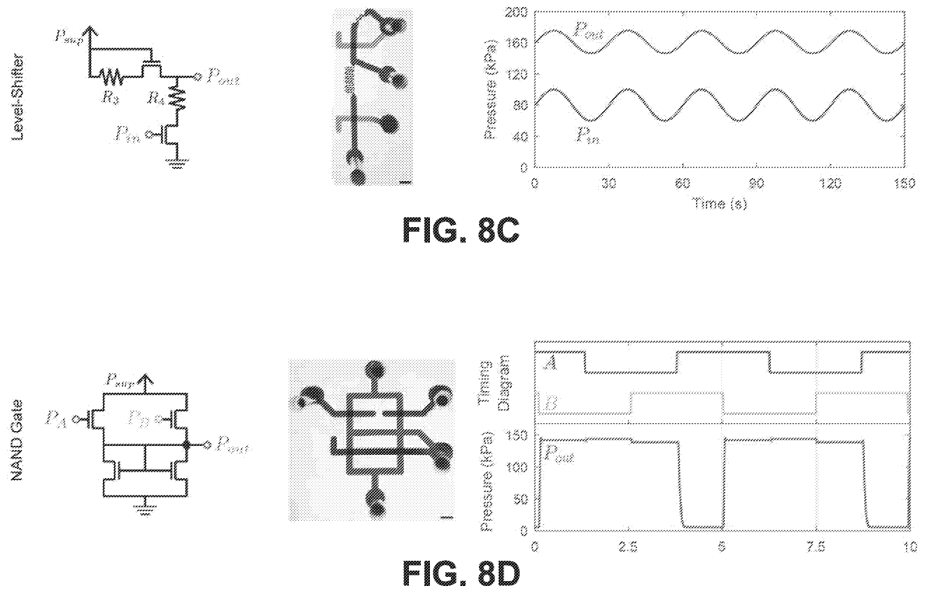

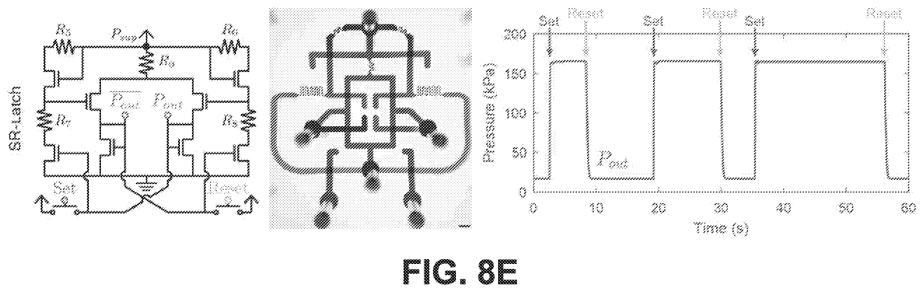

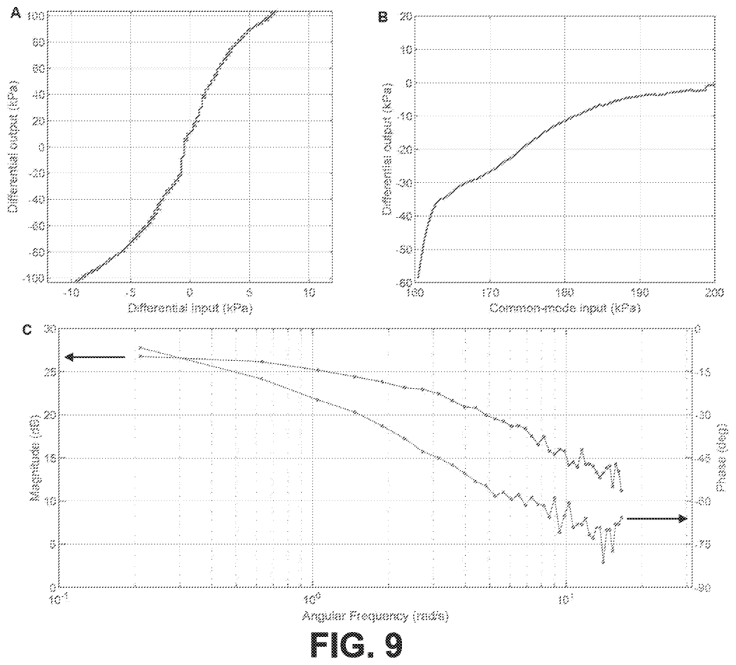

To illustrate the flexibility of the microfluidic transistor and the ease with which it can be directly substituted into pre-existing designs from electronics, we demonstrate the microfluidic analogues to several classic electronic circuit blocks (FIG. 8). For each of these circuits, we also provide several characterization studies to evaluate their performance, similar to the studies typically found in electronic datasheets (FIGS. 9A-9C, 10A-10B, and 11A-11B). The specific component values used in these circuits are provided in Table 2. In this table, the specific values and sizes for the resistors, transistors, and pressure sources used in the circuit schematics are provided. Resistors may be integrated on-chip using a serpentine channel (denoted “Channel”) with a rectangular cross-section, or incorporated into the tubing that leads to the chip ports (denoted “Tube”) with a circular cross-section. Resistances were calculated under laminar flow conditions using the Poiseuille equation (see, e.g., ref. 32).

TABLE 2
Circuit component details

| Component | Value | | Sizing Details | |
|---|---|---|---|---|
| R₁ | 3.0 | kPa s μL⁻¹ | Tube, | |
| | | | Length = | 30 cm, |
| | | | Radius = | 127 μm |
| R₂ | 1.0 | kPa s μL⁻¹ | Channel, | |
| | | | Length = | 2.85 mm, |
| | | | Width = | 250 μm, |
| | | | Height = | 55 μm |
| R_{load} | 2.0 | kPa s μL⁻¹ | Tube, | |
| | | | Length = | 20 cm, |
| | | | Radius = | 127 μm |
| R₃, R₅, R₆ | 2.0 | kPa s μL⁻¹ | Channel, | |
| | | | Length = | 1.8 mm, |
| | | | Width = | 100 μm, |
| | | | Height = | 55 μm |
| R₄ | 11.2 | kPa s μL⁻¹ | Channel, | |
| | | | Length = | 10 mm, |
| | | | Width = | 100 μm, |
| | | | Height = | 55 μm |
| R₇, R₈ | 10.0 | kPa s μL⁻¹ | Channel, | |
| | | | Length = | 8.9 mm, |
| | | | Width = | 100 μm, |
| | | | Height = | 55 μm |
| R₉ | 1.9 | kPa s μL⁻¹ | Channel, | |
| | | | Length = | 1.7 mm, |
| | | | Width = | 100 μm, |
| | | | Height = | 55 μm |
| All transistors | — | | Length = | 500 μm, |
| | | | Width = | 500 μm, |
| | | | Height = | 55 μm |

| | | | |
|---|---|---|---|
| Pₛᵤₚ | 250 | kPa | — |

Since amplification is the defining characteristic of a transistor (see, e.g., ref. 16), we first demonstrate microfluidic transistors in a differential amplifier (FIG. 8A). This analog circuit is designed to amplify an input differential pressure signal by a gain factor of over 20. Additional characterization of the frequency response, common-mode rejection, and distortion for this circuit are provided in FIG. 9. Amplifiers are one of the fundamental building blocks of analog circuits, used ubiquitously in signal processing and feedback control (see, e.g., ref. 17). They are also used as buffers in digital logic.

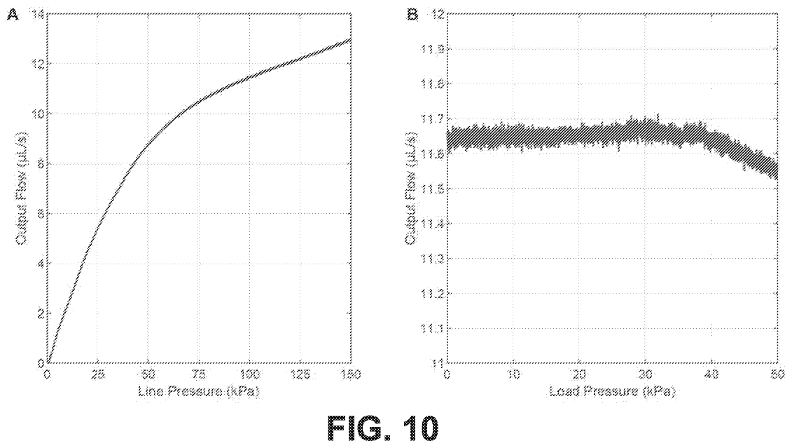

A flow regulator is demonstrated in FIG. 8B. This analog circuit is designed to supply a constant output flow to a downstream load regardless of the input pressure level. Additional characterization of the load and line regulation for this circuit are provided in FIG. 10. Regulators may be used to stabilize flow when microfluidic devices are supplied by unregulated pressure sources (such as balloons or hand pumps) in mobile settings.

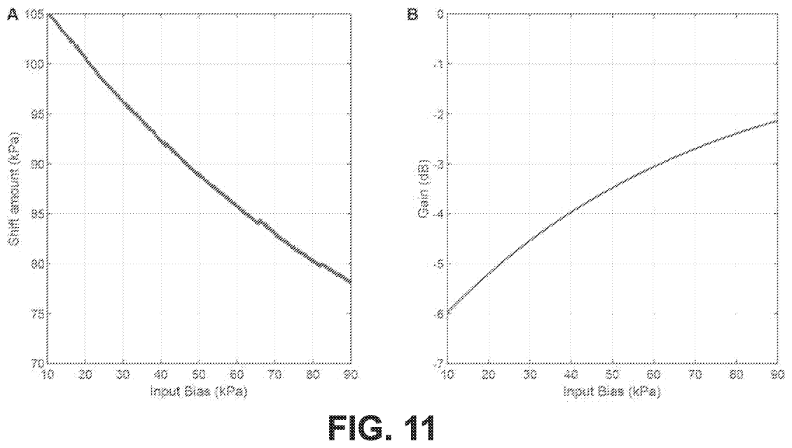

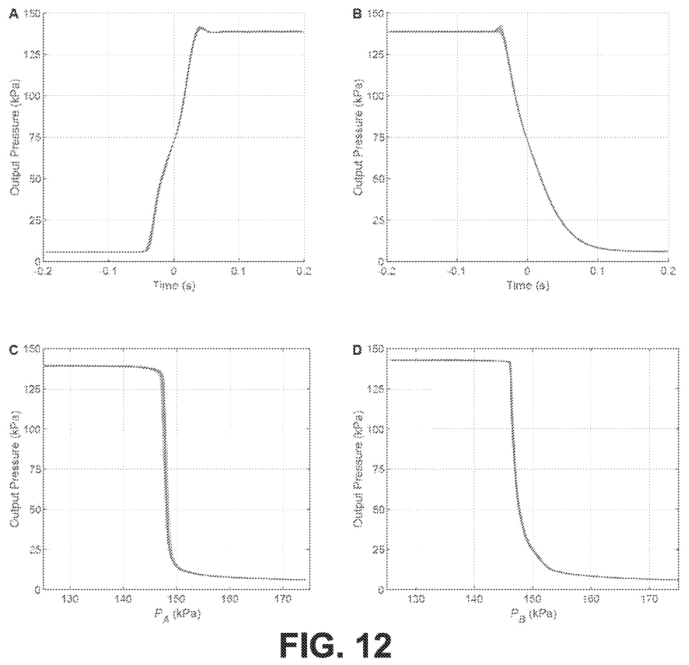

A level-shifter is demonstrated in FIG. 8C. This analog circuit is designed to translate the baseline pressure of the input signal to a higher output baseline pressure without affecting the high-frequency morphology of the signal. Additional characterization of the shift amount and gain for this circuit are provided in FIG. 11. Level-shifters allow multiple circuit blocks to be cascaded with each other, even if they require different biasing pressures, enabling design modularity for analog signal processing.

A NAND gate is demonstrated in FIG. 8D. This digital logic gate produces a low output pressure only if both inputs are at high pressure. NAND gates are universal logic gates, so can be combined to implement all other Boolean logic operations for general digital signal processing. Additional characterization of the slew (circuit dynamics) and transfer characteristics for this circuit are provided in FIG. 12. Logic gates may be used to synchronize fluidic events, perform sequential fluidic operations, or even compute simple binary arithmetic.

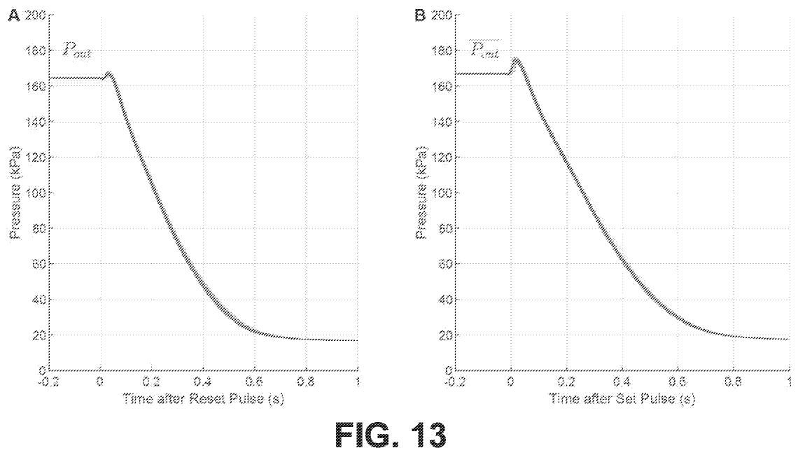

An SR-latch (bistable multivibrator) is demonstrated in FIG. 8E. This digital circuit has two stable output states that can be set high or low persistently after receiving a transient ‘set’ or ‘reset’ pressure pulse. This circuit is composed of a cross-coupled differential amplifier with two level shifters, and so also illustrates how the previously described building blocks can be combined to perform more complex operations. Additional characterization of the slew (circuit dynamics) for this circuit is provided in FIG. 13. Cascaded latches act as fluidic memory and are capable of storing binary numbers. As a result, they may be used to count fluidic events or perform sequential combinatorial operations which require memory of the circuit's previous state.

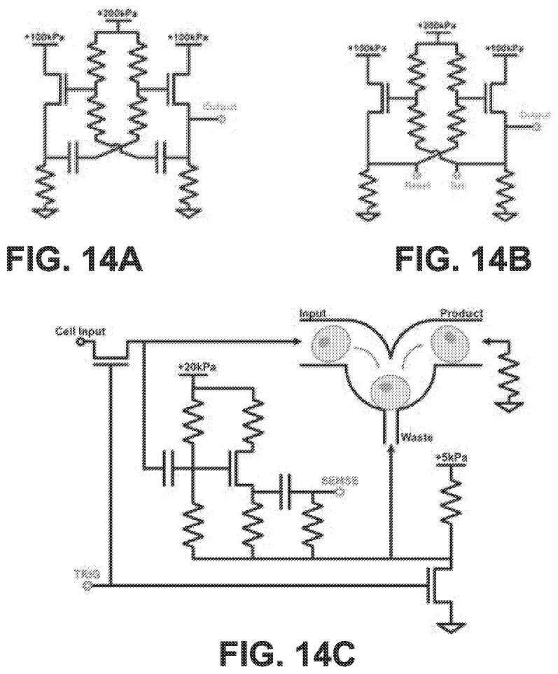

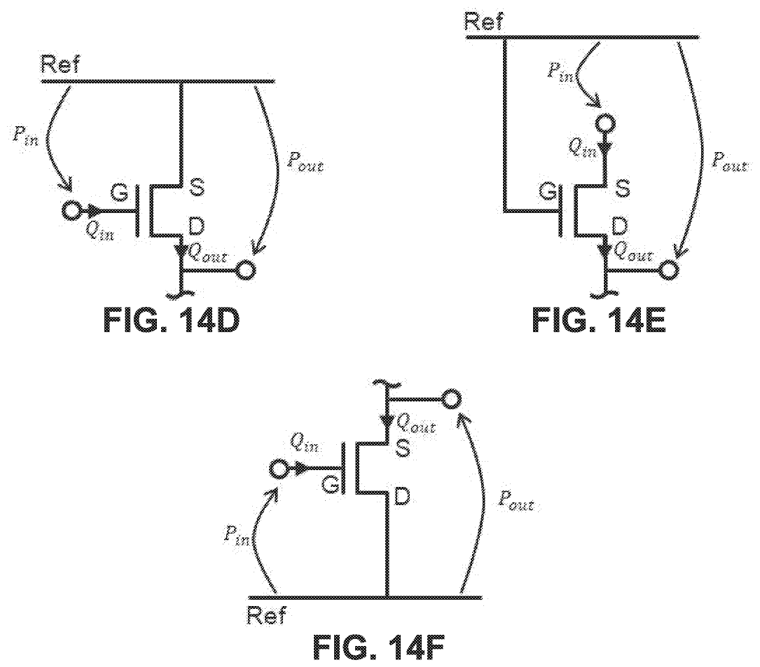

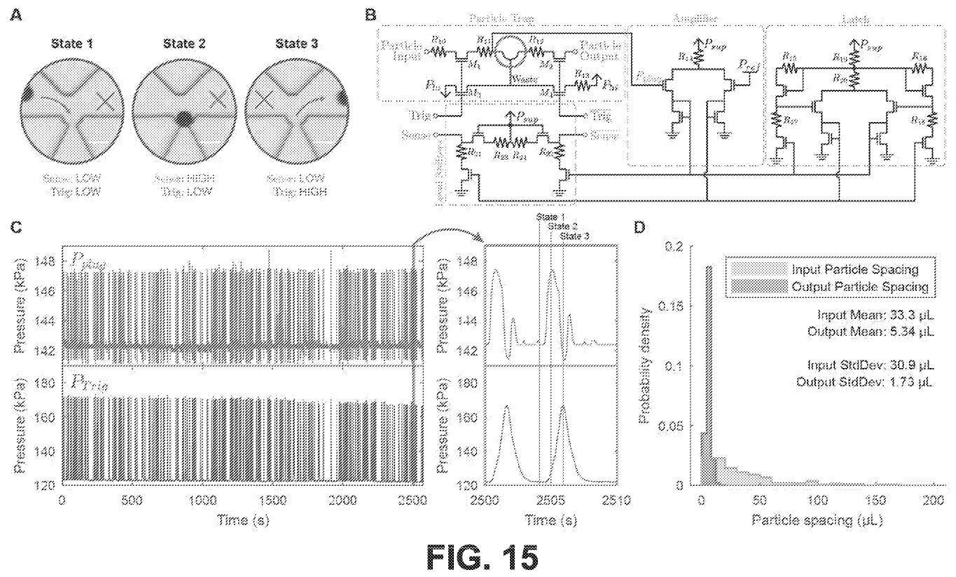

FIG. 14A-14C provides examples of other non-limiting fluidic circuits, including an oscillator circuit that can be configured to have a desired frequency and duty cycle (FIG. 14A), a flip-flop circuit that can be configured to have desired Set and Reset conditions (FIG. 14B), and a fluidic network for use with a microfluidic trap (FIG. 14C). The oscillator circuit in FIG. 14A is a non-limiting example, in which other frequencies (e.g., from 0.05 to 2 Hz) and duty cycles (e.g., from 10% to 90%) may be implemented. Such an oscillator circuit can be characterized, in some non-limiting instances, as a flip-flop circuit. The flip-flop circuit in FIG. 14B can be optimized (e.g., such as in a higher performance circuit for an SR-latch in FIG. 8E). The fluidic network with a microfluidic trap can have any useful configuration, such as in FIG. 14C or in FIG. 15B. This latter network is described more fully in the Example below.

FIG. 14D-14F provides examples of non-limiting topologies for fluidic circuits. Such diagrams of circuit topologies can be converted into its counterpart as fluidic networks, as described herein and as would be understood by a person of skill in the art.

FIG. 14D provides a non-limiting common-source topology. As can be seen, a gate region (G) can be configured to be an input terminal for an input fluidic signal with pressure (Pᵢₙ, as an input pressure signal) and flow (Qᵢₙ, as an input flow signal). The drain region (D) can be configured to be an output terminal for an output fluidic signal (Qₒᵤₜ) with pressure (Pₒᵤₜ, as an output pressure signal) and flow (Qₒᵤₜ, as an output flow signal).

In FIG. 14D, such pressure signals and flow signals can be determined with respect to a source region (S), in which S is provided as a reference (Ref). In some non-limiting embodiments, the terminal for S is held at a substantially non-varying reference pressure. For any flow or pressure signal comparisons herein, a substantially non-varying signal can include a signal that varies within about 20%, 15%, 10%, 8%, 5%, 3%, 2%, 1%, or less of a desired signal; or a signal that is less than about 20%, 15%, 10%, 8%, 5%, 3%, 2%, 1%, or less of a desired signal, or a signal that is more than about 20%, 15%, 10%, 8%, 5%, 3%, 2%, 1%, or less of a desired signal. In other embodiments, a substantially non-varying signal can include a signal that is +/−20%, +/−15%, +/10%, +/−8%, +/−5%, +/−3%, +/−2/, +/−1%, or less of a desired signal.

FIG. 14E provides a non-limiting common-gate topology. As can be seen, a source region (S) can be configured to be an input terminal for an input fluidic signal with pressure (Pᵢₙ, as an input pressure signal) and flow (Qᵢₙ, as an input flow signal). The drain region (D) can be configured to be an output terminal for an output fluidic signal with pressure (Pₒᵤₜ, as an output pressure signal) and flow (Qₒᵤₜ, as an output flow signal).

In FIG. 14E, such pressure signals and flow signals can be determined with respect to a gate region (G), in which G is provided as a reference (Ref). In some non-limiting embodiments, the terminal for G is held at a substantially non-varying reference pressure. A substantially non-varying reference pressure can be, e.g., as provided above in reference to FIG. 14D.

FIG. 14E provides a non-limiting common-drain topology. As can be seen, a gate region (G) can be configured to be an input terminal for an input fluidic signal with pressure (Pᵢₙ, as an input pressure signal) and flow (Qᵢₙ, as an input flow signal). The source region (S) can be configured to be an output terminal for an output fluidic signal with pressure (Pₒᵤₜ, as an output pressure signal) and flow (Qₒᵤₜ, as an output flow signal).

In FIG. 14F, such pressure signals and flow signals can be determined with respect to a drain region (D), in which D is provided as a reference (Ref). In some non-limiting embodiments, the terminal for D is held at a substantially non-varying reference pressure. A substantially non-varying reference pressure can be, e.g., as provided above in reference to FIG. 14D.

As seen in this Example, a microfluidic resistor can be used to manipulate fluid flow, as well as to build fluidic circuits to control fluid flow therein.

### Example 7: Non-Limiting Circuit for Particle Sorting

While the circuits of FIG. 8 demonstrate how the microfluidic transistor can be used to replicate the major building blocks of electronics, we sought to also demonstrate a unique application for the microfluidic transistor that cannot be performed by an electronic transistor: directly manipulating particles suspended in fluids. FIG. 15 demonstrates a “smart” single-particle dispenser capable of sensing and programmatically dispensing individual particles suspended in a fluid. This smart dispenser consists of a microfluidic particle trap at its core, surrounded by microfluidic transistor-based circuit blocks to perform the necessary signal processing for the sensing and dispensing actions.

The operation of the smart dispenser and a diagram of its trap is depicted in FIG. 15A. Normally when there are no suspended particles in the fluid, the output channel is switched off and fluid flows directly from the input to the waste channel (State 1). When a particle is trapped, the input channel pressure P_{plug} rises. This pressure change is then amplified and processed to produce the Sense pressure signal, which indicates that the dispenser holds a trapped particle and is awaiting release (State 2). This output Sense signal may be processed by other fluidic circuit blocks, such as those depicted in FIG. 8, according to the specific dispensing application. If the smart dispenser then receives a Trig pressure signal from the other fluidic circuit blocks, it switches off the input channel, switches on the output channel, and reverses the flow direction through the waste, ejecting the particle into the output channel (State 3). After the particle is dispensed the dispenser returns to its initial state.

FIG. 15B depicts the smart dispenser circuitry, comprising a microfluidic trap (purple) and several previously described circuit blocks. When a particle is trapped, the amplifier block amplifies the small rise in pressure and compares it to a reference threshold, producing a pair of complementary signals indicating the presence of a particle. The latch block ensures the complementarity of the signals and suppresses spurious noise events. Finally, these signals are shifted up using the level-shifter block to produce the output Sense and complementary S̅e̅n̅s̅e̅ signals. The complementary Trig and T̅r̅i̅g̅ signals are used to control the direction of flow in the trap. Details on the specific component values, sizes, and pressures used here are provided in Table 3. In this table, specific values and sizes for the resistors, transistors, and pressure sources used in the circuit schematics are provided. Resistors may be integrated on-chip using a serpentine channel (denoted “Channel”) with a rectangular cross-section, or incorporated into the tubing that leads to the chip ports (denoted “Tube”) with a circular cross-section. Resistances were calculated under laminar flow conditions using the Poiseuille equation (see, e.g., ref. 32).

TABLE 3
Circuit component details

| Component | Value | | Sizing Details | |
|---|---|---|---|---|
| R₁₀, R₁₉ | 3.5 | kPa s μL⁻¹ | Tube, | |
| | | | Length = | 35 cm, |
| | | | Radius = | 127 μm |
| R₁₁, R₁₂ | 4.4 | kPa s μL⁻¹ | Channel, | |
| | | | Length = | 5.7 mm, |
| | | | Width = | 200 μm, |
| | | | Height = | 55 μm |
| R₁₃ | 6.9 | kPa s μL⁻¹ | Tube, | |
| | | | Length = | 70 cm, |
| | | | Radius = | 127 μm |
| R₁₄ | 2.0 | kPa s μL⁻¹ | Tube, | |
| | | | Length = | 20 cm, |
| | | | Radius = | 127 μm |
| R₁₅, R₁₆ | 2.0 | kPa s μL⁻¹ | Channel, | |
| | | | Length = | 1.8 mm, |
| | | | Width = | 100 μm, |
| | | | Height = | 55 μm |
| R₁₇, R₁₈ | 10.0 | kPa s μL⁻¹ | Channel, | |
| | | | Length = | 8.9 mm, |
| | | | Width = | 100 μm, |
| | | | Height = | 55 μm |
| R₂₀ | 1.9 | kPa s μL⁻¹ | Channel, | |
| | | | Length = | 1.7 mm, |
| | | | Width = | 100 μm, |
| | | | Height = | 55 μm |
| R₂₁, R₂₂ | 11.2 | kPa s μL⁻¹ | Channel, | |
| | | | Length = | 10 mm, |
| | | | Width = | 100 μm, |
| | | | Height = | 55 μm |

| | | | |
|---|---|---|---|
| R₂₃, R₂₄ | 2.0 | kPa s μL⁻¹ | Channel, |

| | | | |
|---|---|---|---|
| | | Length = | 1.8 mm, |
| | | Width = | 100 μm, |
| | | Height = | 55 μm |
| M₁, M₂, | | Length = | 1000 μm, |
| M₃, M₄ | | Width = | 1000 μm, |
| | | Height = | 45 μm |
| All transistors | 5 | Length = | 500 μm, |
| except M₁, | | Width = | 500 μm, |
| M₂, M₃, M₄ | | Height = | 55 μm |

| | | | |
|---|---|---|---|
| Pₛᵤₚ | 250 | kPa | — |
| Pₕᵢ | 160 | kPa | — |
| Pₗₒ | 140 | kPa | — |
| P_{ref} | 150 | kPa | — |

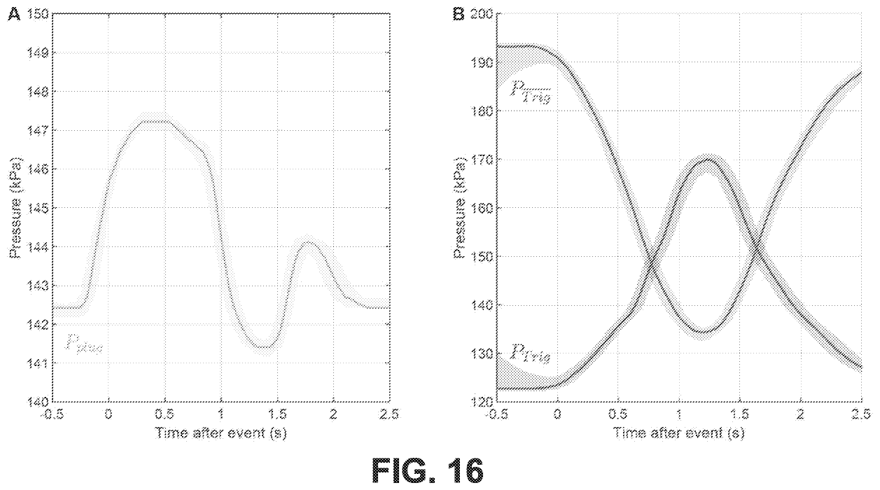

This smart dispenser can offer numerous applications for counting, ordering, encapsulating, and distributing individual particles or biological cells. Here, we demonstrate a simple configuration of the smart dispenser circuit block by connecting the Sense and Trig lines directly to each other. This configuration results in deterministic particle ordering and concentration in the output channel, as demonstrated in FIG. 15C using 40 μm polystyrene beads. While particles at the dispenser input are randomly longitudinally spaced (as a Poisson process) (see, e.g., ref. 21), particles in the dispenser output channel follow a tight distribution of equal spacing along the output stream (FIG. 15D, FIG. 16). The 6-fold drop in the spacing mean and the 17-fold drop in the spacing standard deviation indicates that this configuration of the smart dispenser successfully concentrated and ordered the particles. It is important to note that all the signal processing, particle manipulation, and complex flow control demonstrated here was performed entirely on-chip using microfluidic transistors, requiring only constant pressure sources to supply power.

Although here we illustrated a simple configuration of the dispenser for particle ordering, additional microfluidic transistor-based circuitry (such as those described, for example and without limitation, in FIG. 8A-8E) may be readily integrated for more advanced logic on the Sense and Trig signals to accomplish more complex particle dispensing tasks such as synchronization between multiple dispensers for multi-particle encapsulation or combinatorial operations.

### Example 8: Materials and Methods

Microfluidic Device Fabrication: All devices used in this work were fabricated from two layers of polydimethylsiloxane (PDMS) and a thin silicone membrane (FIG. 5A). Standard soft-lithography techniques were used to fabricate each layer. In brief, SU-8 50 negative photoresist (Kayaku Advanced Materials, Inc.) was spin-coated onto a silicon wafer at 2450 rpm for 30 sec. The channels were patterned onto the SU-8 by exposing the wafer with 365 nm UV radiation through a photomask. The wafer was subsequently developed using Baker BTS-220 SU-8 developer to create the mold for the PDMS. For each device, two such molds were made for the upper and lower PDMS layers. PDMS (Dow Sylgard 184 Kit, Ellsworth Adhesives) was prepared in a 6:1 ratio of base to cross-linker and poured into each mold to create a 4 mm thick layer. The high ratio of cross-linker to base was used to minimize the deformation of the PDMS resistor channels as the channels were pressurized. The PDMS layers were cured in a convection oven for 20 hours at 70° C., then cut and peeled from the mold.

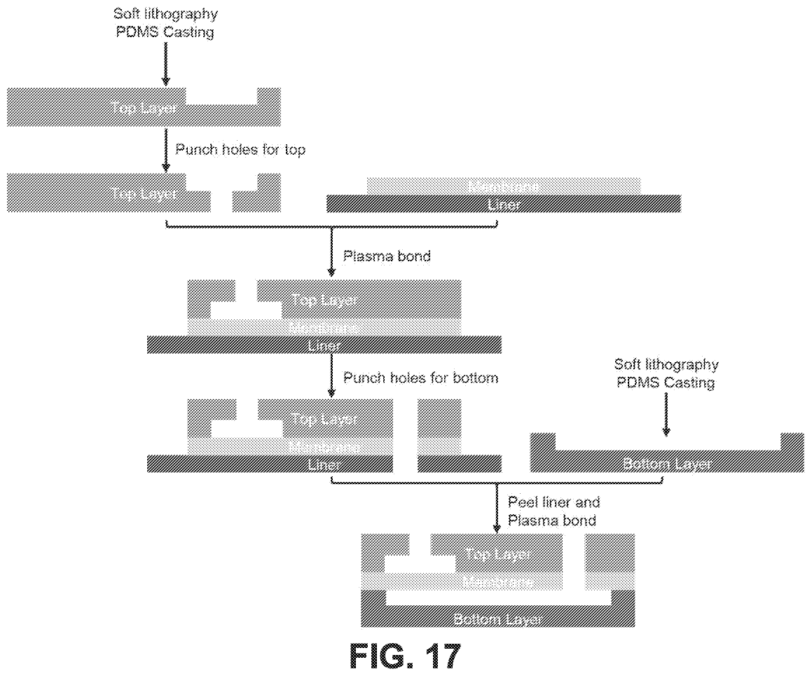

After casting the upper and lower layers of the device from PDMS, they were assembled to make the final microfluidic chips (FIG. 17). A 1.2 mm biopsy punch was used to punch out specific ports in the upper PDMS layer. The PDMS layer was then bonded to a 20 μm thick silicone membrane (Elastosil Film 2030 250/20, Wacker Chemie AG) via oxygen plasma treatment and baked at 80° C. for 15 minutes on a hotplate. A 1.2 mm biopsy punch was then used to create the remaining ports in the bonded assembly of the upper layer and membrane. The membrane side of the assembly was then bonded to the lower PDMS layer via oxygen plasma treatment and baked at 90° C. for 15 minutes on a hotplate. The higher temperature ensured sufficient heat reached the bonding surface through the lower PDMS layer.

Device Setup and Testing: All devices were primed by submerging the device under distilled water and applying a vacuum of approximately −75 kPa for 10 minutes. Air was then slowly released into the vacuum chamber while the devices were submerged, priming the channels with distilled water. Unless otherwise specified, all fluidic connections were made with 0.03-inch inner diameter fluorinated ethylene propylene (FEP) tubing (1520XL, IDEX-HS) and PEEK fittings purchased from IDEX Health & Sciences. The various tubular fluidic resistors were made using 0.01-inch inner diameter FEP tubing (1527L, IDEX-HS). The specific resistor lengths and other component details for each circuit are provided in Tables 1-3. Computer-controlled pressure sources (LineUp FlowEZ, Fluigent) were used to supply pressures for characterization of the microfluidic devices. Unless otherwise specified, all reservoirs for the pressure sources (P-CAP, Fluigent) were filled with 1× phosphate-buffered saline (PBS) (Gibco PBS, Fisher Scientific). All pressure measurements were made using Honeywell pressure sensors (ABPDRRV015PDAA5) and logged on a computer using MATLAB. All flow measurements were made using Sensirion flow meters (SLI-1000).

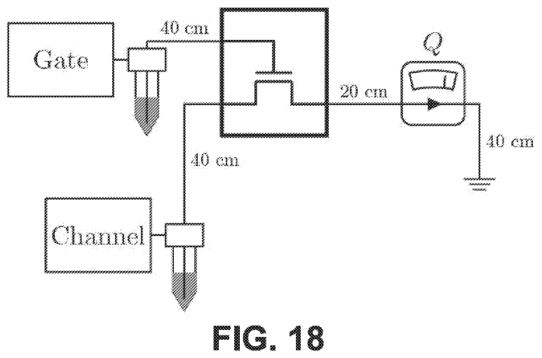

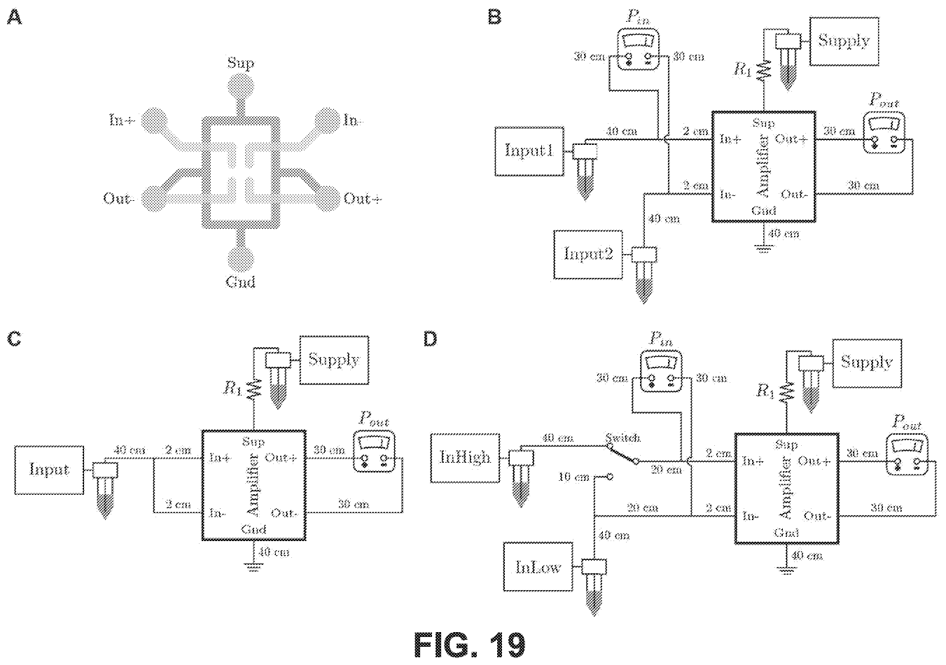

Single Transistor Characterization; FIG. 18 provides the setup used to measure the transistor characteristic curves (FIG. 5C and FIG. 6A). The “Gate” pressure source and the “Channel” pressure source used a Fluigent LU-FEZ-2000 module and a Fluigent LU-FEZ-1000 module respectively to control the pressure. To apply a given P_{SD} and P_{GS} to the device, the pressure at “Channel” was set to P_{SD} and the pressure at “Gate” was set to P_{GS}+P_{SD}. To generate the characteristic curves, P_{GS} was set to 0 kPa, P_{SD} was swept from 0 kPa to 80 kPa over the course of 600 s, and the flow Q was recorded to generate each curve. Then, P_{GS} was incremented by 5 kPa and the process was repeated until P_{GS} reached 80 kPa.

To obtain the intrinsic gain contour plot (FIG. 5D), the two-dimensional surface of points collected from the previous characteristic curve measurements was smoothed using a two-variable rational polynomial function of degree one in the numerator and degree two in the denominator. The smoothed polynomial was confirmed to fit the raw data very well (R²>0.99) and was used to avoid noise when computing the numerical derivatives. The intrinsic gain was then calculated in MATLAB from the smoothed data (Eq. [3.3] in Example 4).

The same setup (FIG. 18) was used to measure the transistor transfer characteristics (FIG. 6B). To generate the transfer characteristic curves, P_{SD} was set to 20 kPa, P_{GS} was swept from 0 kPa to 80 kPa over the course of 300 s, and the flow Q was recorded to generate each curve. Then, P_{SD} was incremented by 20 kPa and the process was repeated until P_{SD} reached 80 kPa.

Amplifier Characterization: FIG. 19B provides the setup used to demonstrate the amplifier (FIG. 8A). The “Supply” pressure source used a Fluigent LU-FEZ-7000 module to control the pressure. The “Input1” and “Input2” pressure sources used two Fluigent LU-FEZ-2000 modules. The tail resistance (R₁) was made using 30 cm of 0.01 in diameter FEP tubing (1527L, IDEX-HS). The “Supply” pressure source was set to 250 kPa. The “Input1” and “Input2” pressure sources applied a common-mode bias of 175 kPa and a differential sinusoidal signal of amplitude 1 kPa and a period of 10 s. The differential input and output signals were measured by pressure sensors.

The same setup (FIG. 19B) was used to measure the amplifier distortion (FIG. 9A). The “Supply” pressure source was set to 250 kPa. Over the course of 150 s, the “Input1” pressure source was swept from 180 kPa to 170 kPa and the “Input2” pressure source was swept from 170 kPa to 180 kPa. The differential input and output signals were measured by pressure sensors.

FIG. 19C provides the setup used to measure the amplifier common-mode rejection (FIG. 9B). The “Supply” and “Input” pressure sources used a Fluigent LU-FEZ-7000 and a Fluigent LU-FEZ-2000 module respectively to control the pressure. The tail resistance (R₁) was made using 30 cm of 0.01 in diameter FEP tubing (1527L, IDEX-HS). The “Supply” pressure source was set to 250 kPa and the “Input” pressure source was swept from 160 kPa to 200 kPa over the course of 150 s. The differential output signal was measured by a pressure sensor.

FIG. 19D provides the setup used to determine the amplifier frequency response (Bode plot) (FIG. 9C). The “Supply” pressure source used a Fluigent LU-FEZ-7000 module to control the pressure. The “InHigh” and “InLow” pressure sources used two Fluigent LU-FEZ-2000 modules. The “Switch” was a Fluigent 2-switch (2SW002). The tail resistance (R₁) was made using 30 cm of 0.01 in diameter FEP tubing (1527L, IDEX-HS). The “Supply” pressure source was set to 250 kPa, the “InLow” pressure source was set to 175 kPa, and the “InHigh” pressure source was set to 177 kPa. The “Switch” was set to toggle every 15 s. The differential input and output signals were measured by pressure sensors and data was collected over 500 s.

To generate the Bode plot of the amplifier (FIG. 9C), the differential input and output signals were resampled to a constant sampling frequency, then converted to the frequency domain. Since a square wave excitation signal in the time domain only produces odd harmonics in the frequency domain, the first 40 odd harmonics of the input and output frequency-domain signals were used to generate the Bode plot points.

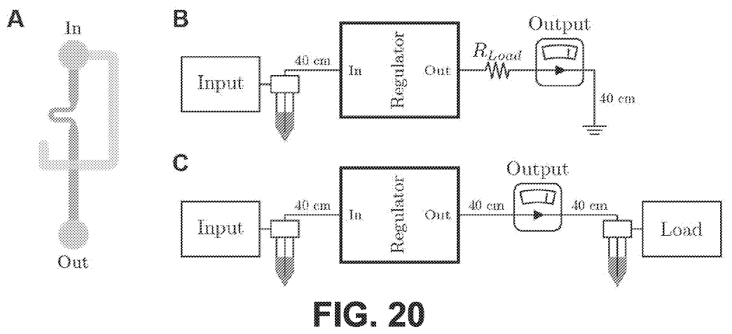

Flow Regulator Characterization: FIG. 20B provides the setup used to demonstrate the flow regulator (FIG. 8B). The “Input” pressure source used a Fluigent LU-FEZ-2000 module to control the pressure. The R_{load} resistance was made using 20 cm of 0.01 in diameter FEP tubing (1527L, IDEX-HS). To simulate a poorly regulated pressure source, the “Input” pressure source was applied an arbitrary randomly-generated pressure waveform ranging from approximately 75 kPa to 150 kPa over the course of 50 s while the flow through the load was recorded.

The same setup (FIG. 20B) was used to measure the line regulation of the flow regulator (FIG. 10A). The R_{load} resistance was made using 20 cm of 0.01 in diameter FEP tubing (1527L, IDEX-HS). The “Input” pressure source was swept from 0 kPa to 150 kPa over the course of 300 s and the flow was recorded.

FIG. 19C provides the setup used to measure the load regulation of the flow regulator (FIG. 10B). The “Line” and “Load” pressure sources used Fluigent LU-FEZ-2000 modules to control the pressures. The “Line” pressure source was set to 100 kPa. The “Load” pressure source was swept from 0 kPa to 50 kPa over the course of 300 s and the flow was recorded.

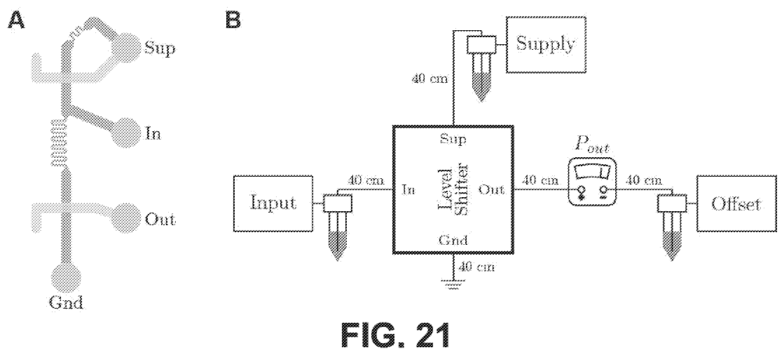

Level Shifter Characterization: FIG. 21B provides the setup used to demonstrate the level shifter (FIG. 8C). The “Supply” and “Input” pressure sources used a Fluigent LU-FEZ-7000 and a Fluigent LU-FEZ-2000 module respectively to control the pressure. The “Offset” pressure source was used to offset the pressure measurement and ensure an appropriate measurement range for the pressure sensor. The “Supply” pressure source was set to 250 kPa, and the “Offset” pressure source was set to 150 kPa. The “Input” pressure source generated a sinusoidal waveform with an amplitude of 20 kPa, a baseline bias pressure of 80 kPa, and a period of 30 s. The output pressure waveform was recorded using a pressure sensor and plotted over 150 s (five periods).

The same setup (FIG. 21B) was used to measure the level shifter shift amount and gain (FIG. 11). The “Supply” pressure source was set to 250 kPa and the “Offset” pressure source was set to 150 kPa. The “Input” pressure source was swept from 10 kPa to 90 kPa over the course of 240 s and the output pressure was recorded. The shift amount was determined by subtracting the output pressure from the pressure applied at the “Input” pressure source. The output pressure data was smoothed using a polynomial function of degree three to remove measurement noise, then the gain was calculated from the derivative. Note that this circuit operates in a common-drain configuration, and so the pressure gain is expected to be less than unity.

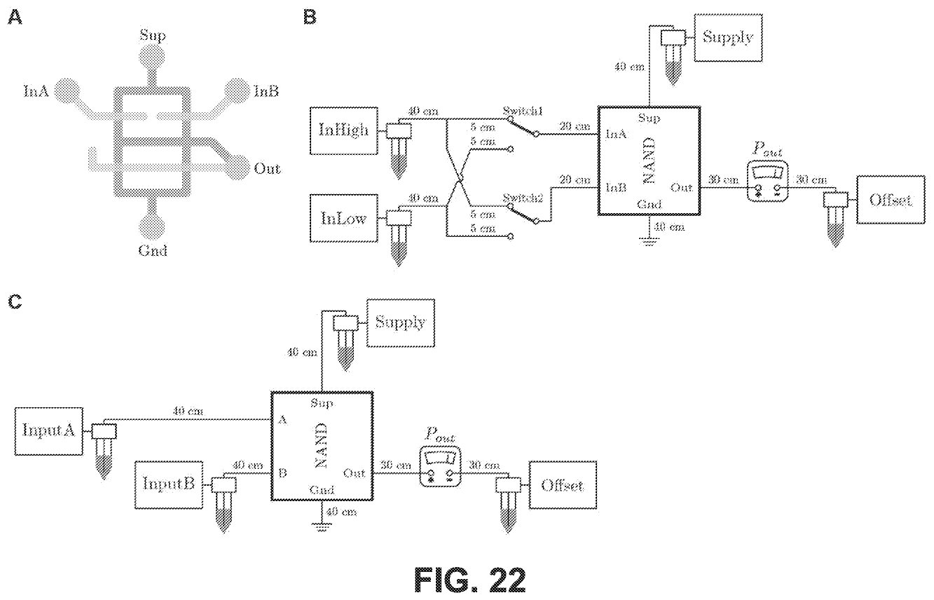

NAND Gate Characterization: FIG. 22B provides the setup used to demonstrate the NAND gate (FIG. 8D). The “Supply” pressure source used a Fluigent LU-FEZ-7000 module to control the pressure. The “InHigh” and “InLow” pressure sources used two Fluigent LU-FEZ-2000 modules. The “Offset” pressure source used a Fluigent LU-FEZ-1000. “Switch1” and “Switch2” were Fluigent 2-switches (2SW002). The “Supply” pressure source was set to 150 kPa, the “Offset” pressure source was set to 100 kPa, the “InLow” pressure source was set to 125 kPa, and the “InHigh” pressure source was set to 175 kPa. Both “Switch1” and “Switch2” were set to toggle every 2.5 s, resulting in two square wave pressure signals with a period of 5 s. The switches were timed such that the two pressure waveforms had a 1.25 s phase delay between them. The output pressure signal was recorded over the course of 300 s.

The same setup (FIG. 22B) was used to measure the NAND gate slew (FIG. 12A-12B), revealing the response dynamics and speed of the circuit. The “Supply” pressure source was set to 150 kPa, the “InLow” pressure source was set to 125 kPa, and the “InHigh” pressure source was set to 175 kPa. “Switch1” was set to toggle every 2.5 s, while “Switch2” was maintained in the top position, connecting the “InB” port to the “InHigh” pressure source. The output pressure signal was recorded over the course of 300 s. Fifty-five individual rising and falling edges were overlaid and plotted.

FIG. 22C provides the setup used to measure the NAND gate transfer characteristics (FIG. 12C-12D). The “Supply” pressure source used a Fluigent LU-FEZ-7000 module to control the pressure. The “InputA” and “InputB” pressure sources used two Fluigent LU-FEZ-2000 modules. The “Offset” pressure source used a Fluigent LU-FEZ-1000. The “Supply” pressure source was set to 150 kPa and the “Offset” pressure source was set to 100 kPa. To measure the Input A transfer characteristics (FIG. 12C), the “Input A” pressure source was swept from 125 kPa to 175 kPa over the course of 15 seconds while “Input B” was held high at 175 kPa. Subsequently, to measure the Input B transfer characteristics (FIG. 12D), the “Input B” pressure source was swept from 175 kPa to 125 kPa over the course of 15 seconds while “Input A” was held high at 175 kPa. The output pressure signal was recorded as these sweeps were repeated ten times each. These transfer characteristics were overlaid and plotted.

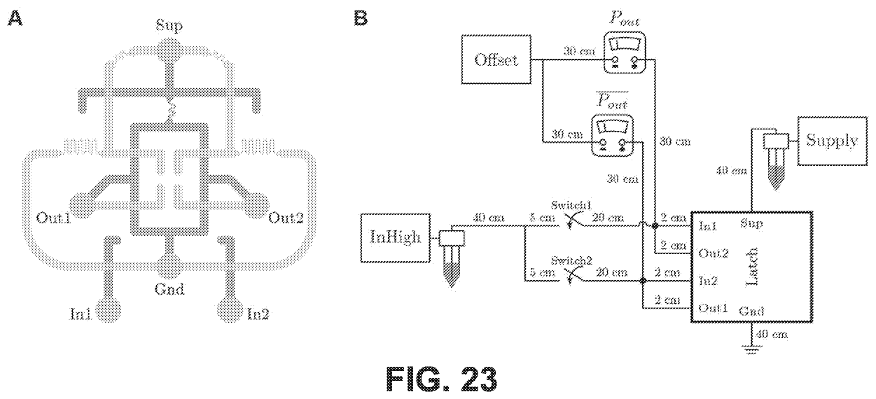

SR-Latch Characterization: FIG. 23B provides the setup used to demonstrate the SR-Latch (FIG. 8E). The “Supply” pressure source used a Fluigent LU-FEZ-7000, the “InHigh” pressure source used a Fluigent LU-FEZ-2000, and the “Offset” pressure source used a Fluigent LU-FEZ-1000. “Switch1” and “Switch2” were Fluigent 2-switches (2SW002) normally in the open state. The “Supply” pressure source was set to 250 kPa, the “InHigh” pressure source was set to 165 kPa, and the “Offset” pressure source was set to 100 kPa. The latch was set by briefly closing and re-opening “Switch1” for the shortest period the Fluigent SDK would allow (typically 0.5 s). The latch was then reset by briefly closing and re-opening “Switch2” for the shortest period the Fluigent SDK would allow (typically 0.5 s). To demonstrate the memory of the latch (FIG. 8E), the output pressures were recorded as it was set and reset with arbitrarily varying time intervals between the set and reset operations.

The same setup (FIG. 23B) was used to measure the SR-latch slew (FIG. 13), revealing the response dynamics and speed of the circuit. The “Supply” pressure source was set to 250 kPa, the “InHigh” pressure source was set to 165 kPa, and the “Offset” pressure source was set to 100 kPa. The set and reset operations were done by briefly closing the switches as described above. In this fashion, the latch was alternatively set and reset every 2.5 s while the output pressures were measured over the course of 300 s. The resulting pressure signal included of sixty individual set edges (FIG. 13A) and sixty individual reset edges (FIG. 13B).

Smart Particle Dispenser Characterization: The concentration and ordering capabilities of the smart particle dispenser circuit were tested using a suspension of polystyrene microspheres in PBS. The suspension was prepared by adding 40 μm diameter polystyrene beads (Fluoro-Max Green 35-7B, Thermo-Fisher) to 50 mL of 1×PBS (Gibco PBS, Fisher Scientific) to achieve a final concentration of approximately 30 beads/mL.

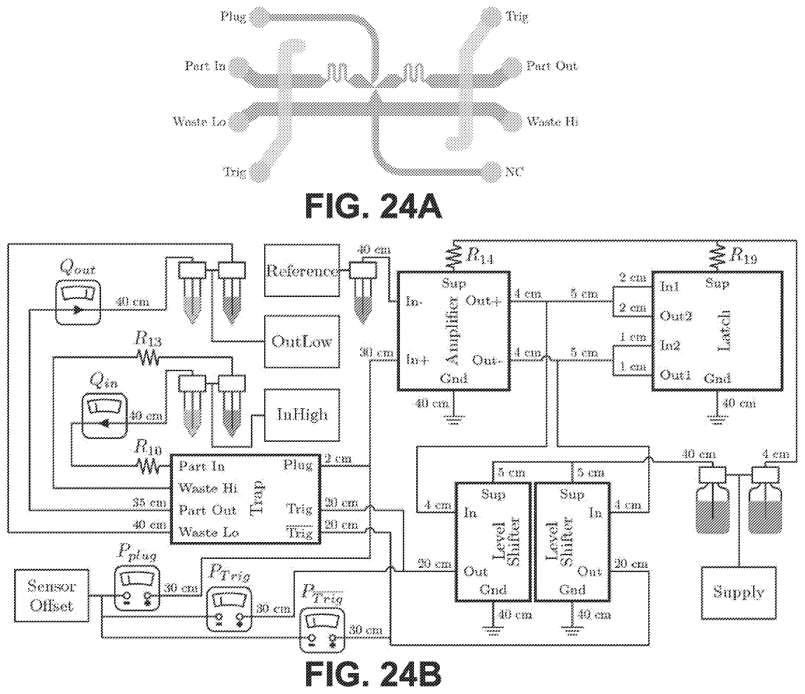

FIG. 24B provides the setup used to test the smart dispenser configured for particle concentration and ordering. The reservoir (light gray) connected to the “Part In” line of the trap was filled with the dilute polystyrene bead suspension and all other reservoirs were filled with PBS. The reservoirs connected to the “Supply” pressure source were 500 mL bottles, while all other reservoirs were P-CAP reservoirs from Fluigent. The “Supply” pressure source used a Fluigent LU-FEZ-7000 module to control the pressure. The “InHigh”, “OutLow”, and “Reference” pressure sources used Fluigent LU-FEZ-2000 modules to control the pressure. The “Sensor Offset” pressure source used a Fluigent LU-FEZ-1000 module to offset the pressure sensors, ensuring an appropriate measurement range. The tubing dimensions used for the resistances are provided in Table 3. The “Supply” pressure source was set to 250 kPa, the “InHigh” pressure source was set to 160 kPa, the “OutLow” pressure source was set to 140 kPa, the “Reference” pressure source was set to 150 kPa, and the “Sensor Offset” pressure source was set to 100 kPa.

All pressure sources remained constant during the entirety of the experiment, since all of the dynamic signal processing was performed by the microfluidic chip itself. Trapping events were consistently detected by a sharp rising edge in the P_{plug} pressure signal, and additionally verified visually under a microscope. Between trapping events, the flow through the “Part In” line (Qᵢₙ) was integrated to compute the input particle spacing volume, and the flow through the “Part Out” line (Qₒᵤₜ) was integrated to compute the output particle spacing volume. The experiment was run for 230 trapping events before the “Supply” reservoirs of liquid to power the system were depleted.

### Example 9: Microfluidic Transistors for Liquid Signal Processing

Using microfluidic transistors for complex flow control has several significant advantages over prior methodologies. Many microfluidic systems use external computers that switch on or off individual electromechanical or pneumatic valves embedded in the microfluidic chip (see, e.g., ref. 10-12). Unfortunately, these off-chip approaches are practically limited in complexity and scalability due to the difficulty in interfacing the microfluidic chip with the external electronics and the large footprint of the many external electrical or pneumatic control lines needed (see, e.g., ref. 14, 22). Performing signal processing entirely in the fluidic domain circumnavigates this key deficiency.

As the precision and complexity requirements of microfluidic applications grow, controlling the flow of reagents, droplets, and cells on these platforms has become increasingly challenging (see, e.g., ref. 14, 22, 33). Microfluidic platforms have conventionally addressed the problem of complex flow control with embedded electromechanical or pneumatic valves actuated by external computer controllers (see, e.g., ref. 10-12). However, these external control systems are challenging to scale and limit the complexity of the fluidic operations that can be performed (see, e.g., ref. 2, 14, 22). More recent work has resulted in the development of miniature self-actuated valves that function without an external controller (see, e.g., ref. 25, 26). While the valves in these systems are capable of switching flows on or off in simple fluidic circuits, they do not replicate the saturation behavior of the transistor, and cannot amplify an analog signal—the defining feature of the transistor (see, e.g., ref. 16, 17). Without this characteristic saturation behavior, these microfluidic valves cannot be used to perform analog signal processing, and limit the potential of applying modular, complex circuit designs from electronics towards the scalable control of liquids on a chip.

One technical advance of this study is to exploit the fluidic phenomenon of flow-limitation to create a microfluidic transistor that replicates all of the electronic transistor operating regimes (e.g., linear, cut-off, and saturation). After characterizing this microfluidic transistor, we use it to demonstrate microfluidic analogues for several classic electronic building blocks including the amplifier, regulator, level shifter, NAND gate, and SR-latch. These circuit blocks enable modular liquid signal processing on-chip without external controllers. Finally, to showcase the microfluidic transistor's ability to directly manipulate particles suspended in fluids, we demonstrated a “smart” particle dispenser. This dispenser is capable of sensing single suspended particles, performing signal processing operations, and dispensing the particles in a controllable manner. We integrated this dispenser along with several other microfluidic transistor-based circuit blocks into a self-contained system that automatically performs deterministic single-particle ordering and concentration without any external optical or electronic components.

Our approach to complex flow control is fundamentally distinct from the existing repertoire of valve-based microfluidic systems. Building off early advances from the Quake group (see, e.g., ref. 10 and 23) and Mathies group (see, e.g., ref. 24), recent valve-based microfluidic systems use movable membranes (“switch valves”) (see, e.g., ref. 22 and 25) or embedded rigid disks (“gain valves”) (see, e.g., ref. 26 and 27) to control the flow of fluid through a channel. Unlike the microfluidic transistors described in this work, microfluidic valves do not exploit the flow-limitation phenomenon and instead rely on physically blocking the flow channel by moving a sealing surface. As a result, these valves behave akin to an electronic relay that switches flows entirely on or off. These valves have been used to make a number of digital circuits, including logic gates, clocks, and latches (see, e.g., ref. 22 and 26). However, since these valves do not replicate the saturation regime of the transistor and do not have an intrinsic gain, they cannot be used to build a large class of analog circuits, including the amplifier, regulator, level shifter, and smart particle dispenser shown here. Additionally, these sealing-surface approaches suffer from unequal opening and closing pressure thresholds that can even vary based on surrounding circuitry, making circuit design challenging and limiting the scale of digital circuitry they could be used for as well (see, e.g., ref. 28).

The microfluidic transistor described here replicates all the regimes of operation of the electronic transistor and demonstrates a large region of high intrinsic gain suitable for both analog amplification and digital logic. It can be easily fabricated and used to directly translate a number of classic building block circuits from analog and digital electronics, functioning without any external control pneumatics, electronics, or optics. Thanks to this self-contained nature, these circuit blocks are modular and may be readily scaled and interconnected using amplifiers and level-shifters to produce large-scale integration on a single microfluidic chip. Combining this scalable signal processing transistor circuitry with the transistor-based smart particle dispenser unlocks the breadth and depth of electronic circuit design for the next generation of biological and chemical processing using microfluidics.

We exploited this fluidic phenomenon (flow-limitation) to develop a microfluidic analogue to the transistor. Just as the electronic transistor revolutionized the control and processing of electronic signals, a microfluidic transistor could enable similar improvements in the control of reagents, single cells, and droplets for advanced biological and chemical platforms. Prior efforts towards creating a microfluidic transistor could not replicate the electronic transistor's saturation behavior, which is essential to its function and used ubiquitously in modern circuit design. We report three findings in our work:
1. The development of the first microfluidic element that replicates all the transistor operating regimes (linear, cut-off, and saturation) in the liquid domain. We also propose a model for its flow-pressure characteristics based on the flow-limitation phenomenon.
2. The one-to-one translation of a range of classic electronic circuit designs into functioning fluidic circuits. Each of these microfluidic circuits were used to perform both analog and digital pressure signal processing operations on liquids, and characterized in a manner similar to what is done in an electronic datasheet.
3. The creation of a purely microfluidic dispensing system that senses individual suspended particles, performs liquid signal processing, and accordingly controls the movement of said particles without any electronics. This dispensing system was configured to perform single-particle ordering and concentration in a fully deterministic fashion, utilizing several complex fluidic circuit blocks working in unison to process each particle.

By demonstrating the ability to both process liquid signals and manipulate individual particles based on those signals, our work may be used to perform operations on reagents and cells with unprecedented levels of complexity and controlling capabilities. In biotechnology, it may be used to manipulate single cells, such as in high throughput drug screening, cell-cell interaction assays, and droplet-based ‘omics’ platforms. In chemical engineering, it may be used to control microreactors at scale for drug discovery and combinatorial chemistry. Finally, there are also applications for mobile diagnostic technologies, smart wearable devices, and control logic for soft robotics.

### Example 10: Non-Limiting Embodiment of a Microfluidic Transistor

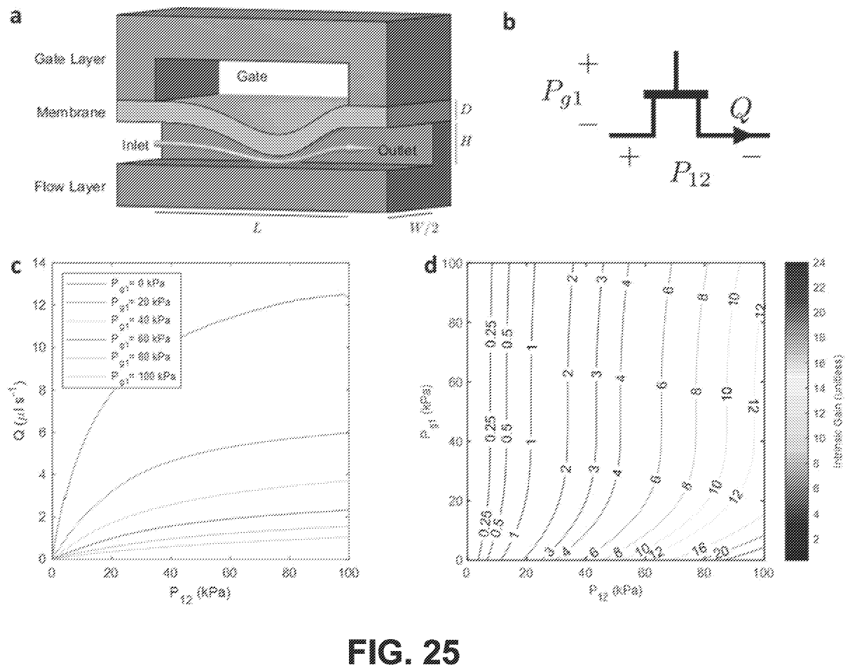

In one embodiment, the transistor includes two crossed channels of fluid separated by a thin elastomer membrane (FIG. 25A). As the pressure rises in one channel (“gate channel”), the deforming membrane restricts flow through the other channel (“flow channel”). A non-limiting fluidic element is represented by the schematic in FIG. 25B, where the relevant flow and pressures are also labelled. Due to the crossed architecture, the length and width of the transistor are determined by the widths of the gate channel and flow channel respectively. The gate and flow channel layers are fabricated from PDMS using standard soft-lithography techniques and bonded to both sides of a PDMS membrane under oxygen plasma. Other materials and fabrication methods may be employed.

FIG. 25C shows the characteristic curves for a transistor with a length L of 250 μm, width W of 250 μm, and height H of the flow channel 50 μm. The membrane has a Young's modulus E of 550 kPa and a thickness D of 20 μm. The element is characterized in a fashion similar to that of a p-channel junction FET (p-JFET), where each curve is generated by varying the pressure drop across the flow channel P₁₂ and measuring the flow Q. Individual curves are generated by holding the pressure between the gate and the inlet (P_{g1}) at different constant values during the sweep. This results in the fluidic version of the classic transistor characteristic curves. Other standard characterization studies, such as parasitics, response time, and hysteresis may be found herein.

A critical characterization for any transistor is its intrinsic gain, a dimensionless measure of the maximum small-signal amplification at a given operating point (see, e.g., ref. v). For an element to amplify like a transistor, it must have a large region of operation where the intrinsic gain is greater than unity.

The intrinsic gain Aₘ for a fluidic transistor that maintains a flow Q while operating at pressures P_{g1} and P₁₂ is given by the following:

$${A}_{m} = \frac{\partial Q}{\partial {P}_{g 1}} {( \frac{\partial Q}{\partial {P}_{12}} )}^{- 1} . \qquad [ 5 ]$$

FIG. 25D shows a contour plot of the intrinsic gain as a function of operating P_{g1} and P₁₂ computed from the characterization of FIG. 25C. It shows a large operating region where the intrinsic gain is much greater than unity, indicating that the element is capable of greatly amplifying analog signals at a variety of operating points.

These microfluidic transistors were able to achieve high intrinsic gains by exploiting the fluidic phenomenon of flow-limitation. In this phenomenon, increasing the pressure drop P₁₂ beyond a threshold does not substantially increase the flow rate Q. This may be observed in FIG. 25C as the flattening of the flow curves at high P₁₂ pressures. As ∂Q/∂P₁₂ becomes small, the transistor achieves high intrinsic gain Aₘ. While this flow-limitation phenomenon has been observed in macroscopic systems, it has not previously been exploited to amplify fluidic signals. An analogous effect, the pinch-off phenomenon, is used by electronic FETs to achieve their high intrinsic gains.

There is a large parameter space to explore for different fluidic transistor geometries and materials, so a designer may pick a geometry for whatever characteristics are required for their application. Moreover, since the characteristics can be influenced by changes in geometry, a single microfluidic chip may hold multiple transistors whose characteristics vary by many orders of magnitude. While the mathematical parameter space of flow-limitation has not been fully explored, empirical characterization of a number of microfluidic transistors can be implemented with various channel geometries to act as a reference for future designs.

To showcase the flexibility of the fluidic transistor and the ease at which it can be substituted into pre-existing designs from electronics, we demonstrate the fluidic implementation of several classic electronic circuit designs. An example common-source differential amplifier is shown herein (see FIG. 8A). Besides being fundamental in nearly all analog circuit designs, amplifiers are used in digital logic gates as well as control loop circuits.

A flow-regulator is demonstrated herein (see FIG. 8B) that uses negative feedback to supply a constant output flow regardless of the input pressure level. Flow or pressure regulators may be used to power other microfluidic devices from poor pressure sources (such as balloons or hand pumps) in point-of-care settings.

An oscillator circuit (a stable multivibrator) is shown in FIG. 14A, which can be designed to output a desired oscillatory pressure signal. Oscillators are the basis for timers and counting events. They may also be used for most advanced applications requiring switching flows, such as biochemical clocking and inertial focusing.

A flip-flop circuit (bistable multivibrator) is shown in FIG. 14B, which can be capable of entering two stable states and storing one bit of memory. The STATE output may be moved to high or low using a current pulse to SET or RESET respectively. These flip-flop circuits may be chained together to count events, perform combinatorial operations, or create state machines. Notably, all of these classic circuit designs are well-studied in the field of electronics, so designing the fluidic versions may be done by replacing each circuit element in place.

Finally, to showcase the relevance of the transistor element for biological applications, we demonstrate a novel single-cell trap with individually triggered cell release. This trap is capable of sensing when a cell has become trapped, and is additionally able to release that cell to a separate product channel when triggered by an external pressure pulse. The trap consists of fluidic circuitry surrounding a three-channel well design similar to previous microfluidic cell traps with an input channel, a product channel, and a narrow waste channel (FIG. 14C). Normally, the product channel is closed, so liquid may flow directly from input to waste. When a cell occludes the waste channel, a pressure difference is generated between input and waste channels, which is amplified to produce the SENSE signal. With this amplification, the SENSE signal gains noise immunity and is capable of interfacing reliably with other circuitry. No additional flow occurs until a pressure pulse is sent to the TRIG signal, which closes the input channel and opens the product channel, triggering the cell to exit the trap.

This cell trap has numerous applications for counting, ordering, and dispensing individual cells for microfluidic applications. For example, connecting the SENSE port directly to the TRIG port results in deterministic cell ordering, where each cell is equally spaced longitudinally in the product stream. This feedback diverts the input volume to the waste when no cell is detected, and diverts the input volume to the product only when a cell is detected. This deterministic cell ordering circuit may be used in a number of cell-droplet encapsulation technologies, including single-cell sequencing and drug screening.

Our approach to complex flow control for microfluidic circuits has several key advantages over existing techniques. Some approaches use external devices to switch flows on or off, such as electronically-controlled pneumatic valves, where the logic of flow control is relegated to an external computer. However, these approaches are practically limited in complexity and scalability due to the difficulty in interfacing the microfluidic chip with the external electronics or the large footprint of the many external pneumatic control lines needed.

Other approaches use on-chip chemical signals to open or close hydrogel valves. These chemical approaches limit the types of fluids that can be used in the chip and take minutes-to-hours to reach steady-state. The gain valve developed by Weaver et al. is capable of using a smaller pressure to switch on or off a larger flow due to an implanted rigid disk, analogous to an electronic relay. However, this binary device is not capable of amplifying an analog signal, preventing it from being used in a large class of circuit designs, including for example the amplifier, regulator, and single-cell detector trap described here.

All the circuits described herein perform their functions without any external control, electronics, or optics and only utilize an external power source (either a pressure source or syringe pump). Thanks to this self-contained nature, these circuits are modular and may be easily scaled or connected to each other using amplifiers and buffers to produce much more complex flow operations on a single microfluidic chip. Combining this scalable circuitry with the single-cell detector trap described here can leverage the breadth of circuit design to the processing of biological and chemical materials.

Whilst the invention has been disclosed in particular embodiments, it will be understood by those skilled in the art that certain substitutions, alterations and/or omissions may be made to the embodiments without departing from the spirit of the invention. Accordingly, the foregoing description is meant to be exemplary only, and should not limit the scope of the invention. All references (including those listed above), scientific articles, patent publications, and any other documents cited herein are hereby incorporated by reference for the substance of their disclosure.

### REFERENCES

i. P. Horowitz, W. Hill. The Art of Electronics (New York. Cambridge Univ. Press, 1989).
ii. G. M. Whitesides, The origins and the future of microfluidics, Nature. 442, 368-373 (2006).
iii. Q. Zhang, M. Zhang, L. Djeghlaf, J. Bataille, J. Gamby, A.-M. Haghiri-Gosnet, A. Pallandre, Logic digital fluidic in miniaturized functional devices: Perspective to the next generation of microfluidic lab-on-chips. Electrophoresis. 38, 953-976 (2017).
iv. H. S. Black, Stabilized feedback amplifiers, Bell Syst. Tech. J. 13, 1-18 (1934).
v. A. S. Sedra, K. C. Smith. Microelectronic Circuits (New York. Oxford University Press, 2004).
1. G. M. Whitesides, The origins and the future of microfluidics. Nature. 442, 368-373 (2006).
2. S. M. Prakadan, A. K. Shalek, D. A. Weitz, Scaling by shrinking: empowering single-cell “omics” with microfluidic devices. Nat. Rev. Genet. 18, 345-361 (2017).
3. E. Z. Macosko, A. Basu, R Satija, J. Nemesh, K. Shekhar, M. Goldman, I. Tirosh, A. R. Bialas, N. Kamitaki, E. M. Martersteck, J. J. Trombetta, D. A. Weitz, J. R. Sanes, A. K. Shalek, A. Regev, S. A. McCarroll, Highly parallel genome-wide expression profiling of individual cells using nanoliter droplets. Cell. 161, 1202-1214 (2015).
4. A. M. Klein, L. Mazutis, 1. Akartuna, N. Tallapragada, A. Veres, V. Li, L. Peshkin, D. A. Weitz, M. W. Kirschner, Droplet barcoding for single-cell transcriptomics applied to embryonic stem cells. Cell. 161, 1187-1201 (2015).
5. (a) A. J. DeMello, Control and detection of chemical reactions in microfluidic systems. Nature. 442, 394-402 (2006); (b) K. S. Elvira, X. C. I Solvas, R C. R. Wootton, A. J. Demello, The past, present and potential for microfluidic reactor technology in chemical synthesis. Nature Chemistry 5, 905-915 (2013).
6. (a) P. S. Dittrich, A. Manz, Lab-on-a-chip: Microfluidics in drug discovery. Nat. Rev. Drug Discov. 5, 210-218 (2006); (b) G. Schneider, Automating drug discovery. Nat. Rev. Drug. Discov. 17, 97-113 (2018).
7. (a) E. K. Sackmann, A. L. Fulton, D. J. Beebe, The present and future role of microfluidics in biomedical research. Nature. 507, 181-189 (2014); (b) P. Yager, T. Edwards, E. Fu, K. Helton, K. Nelson, M. R. Tam, B. H. Weigl, Microfluidic diagnostic technologies for global public health. Nature 442, 412-418 (2006).
8. M. Baker, Digital PCR hits its stride. Nat. Methods. 9, 541-544 (2012).
9. L. A. Low, C. Mummery, B. R. Berridge, C. P. Austin, D. A. Tagle, Organs-on-chips: into the next decade. Nat. Rev. Drug Discov. 20, 345-361 (2021).
10. M. A. Unger, H. P. Chou, T. Thorsen, A. Scherer, S. R. Quake, Monolithic microfabricated valves and pumps by multilayer soft lithography. Science. 288, 113-116 (2000).
11. J.-Y. Qian, C.-W. Hou, X.-J. Li, Z.-J. Jin, Actuation Mechanism of Microvalves: A Review. Micromachines. 11, 172 (2020).
12. W. Gu, X. Zhu, N. Futai, B. S. Cho, S. Takayama, Computerized microfluidic cell culture using elastomeric channels and Braille displays. Proc. Natl. Acad. Sci. U.S.A 101, 15861-15866 (2004).
13. F. Eduati, R. Utharala, D. Madhavan, U. P. Neumann, T. Longerich, T. Cramer, J. Saez-Rodriguez, C. A. Merten, A microfluidics platform for combinatorial drug screening on cancer biopsies. Nat. Commun. 9, 2434 (2018).
14. S. J. Kim, D. Lai, J. Y. Park, R Yokokawa, S. Takayama, Microfluidic automation using elastomeric valves and droplets: Reducing reliance on external controllers. Small. 8, 2925-2934 (2012).
15. D. T. Chiu, A. J. deMello, D. Di Carlo, P. S. Doyle, C. Hansen, R. M. Maceiczyk, R. C. R. Wootton, Small but Perfectly Formed?Successes, Challenges, and Opportunities for Microfluidics in the Chemical and Biological Sciences. Chem. 2, 201-223 (2017).
16. P. Horowitz, W. Hill, The Art of Electronics (New York: Cambridge University Press, ed. 3rd, 2015).
17. A. S. Sedra, K. C. Smith, Microelectronic Circuits (New York: Oxford University Press, 2010).
18. A. H. Shapiro, Steady Flow in Collapsible Tubes. J. Biomech. Eng. 99, 126 (1977).
19. T. A. Wilson, J. R. Rodarte, J. P. Butler, “Wave-Speed and Viscous Flow Limitation” in Comprehensive Physiology (John Wiley & Sons, Inc., Hoboken, NJ, USA, 2011; http://doi.wiley.com/10.1002/cphy.cp030305), pp. 55-61.
20. M. P. Païdoussis, Wave propagation in physiological collapsible tubes and a proposal for a Shapiro number. J. Fluids Struct. 22, 721-725 (2006).
21. D. J. Collins, A. Neild, A. deMello, A. Q. Liu, Y. Ai, The Poisson distribution and beyond: Methods for microfluidic droplet production and single cell encapsulation. Lab Chip. 15, 3439-3459 (2015).
22. B. Mosadegh, T. Bersano-Begey, J. Y. Park, M. A. Burns, S. Takayama, Next-generation integrated microfluidic circuits. Lab Chip. 11, 2813-2818 (2011).
23. T. Thorsen, S. J. Maerkl, S. R. Quake, Microfluidic large-scale integration. Science. 298, 580-584 (2002).
24. W. H. Grover, R H. C. Ivester, E. C. Jensen, R. A. Mathies, Development and multiplexed control of latching pneumatic valves using microfluidic logical structures. Lab Chip. 6, 623-631 (2006).
25. B. Mosadegh, C.-H. Kuo, Y.-C. Tung, Y. Torisawa, T. Bersano-Begey, H. Tavana, S. Takayama, Integrated elastomeric components for autonomous regulation of sequential and oscillatory flow switching in microfluidic devices. Nat. Phys. 6, 433-437 (2010).
26. J. A. Weaver, J. Melin, D. Stark, S. R Quake, M. A. Horowitz, Static control logic for microfluidic devices using pressure-gain valves. Nat. Phys. 6, 218-223 (2010).
27. Q. Zhang, M. Zhang, L. Djeghlaf, J. Bataille, J. Gamby, A.-M. M. Haghiri-Gosnet, A. Pallandre, Logic digital fluidic in miniaturized functional devices: Perspective to the next generation of microfnuidic lab-on-chips (Wiley-VCH Verlag, 2017; http://doi.wiley.com/10.1002/elps.201600429), vol. 38.
28. S. J. Kim, R Yokokawa, S. Takayama, Analyzing threshold pressure limitations in microfluidic transistors for self-regulated microfluidic circuits. Appl. Phys. Lett. 101, 234107 (2012).
29. J. E. Mark, Polymer Data Handbook (New York: Oxford University Press, 1999).
30. Wacker Chemie AG, ELASTOSIL® Film|Ultrathin Silicone Film for High-Precision Solutions (available at https://www.wacker.com/h/medias/7091-EN.pdf).
31. P. H. Brown, A. Balbo, H. Zhao, C. Ebel, P. Schuck, Density contrast sedimentation velocity for the determination of protein partial-specific volumes. PLoS One. 6, e26221 (2011).
32. H. Bruus, Theoretical Microfluidics (New York: Oxford University Press, 2008).
33. S. Battat, D. A. Weitz, G. M. Whitesides, G. M. An outlook on microfluidics: the promise and the challenge. Lab Chip 22, 530 (2022).
34. R J. Whittaker, S. L. Waters, O. E. Jensen, J. Boyle, M. Heil. The energetics of flow through a rapidly oscillating tube. Part 1. General theory. J. Fluid Mech. 648, 83-121 (2010).
35. K. Berkouk, P. W. Carpenter, A. D. Lucey. Pressure Wave Propagation in Fluid-Filled Co-Axial Elastic Tubes Part 1: Basic Theory. J. Biomech. Eng. 125, 852-856 (2003).
36. X. Y. Luo, T. J. Pedley. Multiple solutions and flow limitation in collapsible channel flows. J. Fluid Mech. 420, 301-324 (2000).
37. J. J.-S. Shin. A spectral element formulation for fluid-structure interactions: applications to flow through collapsible channels. Ph.D. Dissertation in the Department ofMechanical Engineering, Massachusetts Institute of Technology, 1996, 130 pp.

1. A fluidic transistor comprising:
a flow region configured to transport a first fluid;
a gate region configured to contain a second fluid; and
a deformable region disposed between the flow and gate regions, wherein the deformable region is configured to induce flow-limitation as the first fluid is transported within the flow region.

2. The fluidic transistor of claim 0, wherein a deformation of the deformable region induces the flow-limitation of the first fluid in the flow region; or wherein the deformable region is configured to provide the first fluid at a velocity that is at or faster than a characteristic propagation velocity for the flow region.

3. The fluidic transistor of claim 0, wherein an intrinsic gain of the fluidic transistor is greater than one.

4. (canceled)

5. The fluidic transistor of claim 0, wherein the flow region is disposed above or below the gate region, or wherein the flow region is disposed beside the gate region.

6. The fluidic transistor of claim 0, wherein the flow region comprises a characteristic dimension from about 10 nm to about 1 mm and/or a cross-sectional area of about 100 nm² to about 1 mm².

7. The fluidic transistor of claim 0, wherein the deformable region comprises a flexural rigidity of about 10⁻²³ J to 10⁻³ J, a Young's modulus of about 100 kPa to about 500 GPa, and/or a Poisson ratio of about 0.2 to about 0.5.

8. The fluidic transistor of claim 0, wherein the deformable region comprises an elastomer, a silicon oxide, a thin metal layer, a thin polymer layer, a silicon layer, or a combination thereof.

9. (canceled)

10. The fluidic transistor of claim 0, further comprising:
a flow channel comprising an inlet serving as a source and an outlet serving as a drain, wherein the flow region is disposed within the flow channel and wherein the flow channel is configured to transport the first fluid from the source to the drain; and
a gate channel comprising an inlet and an outlet, wherein the gate region is disposed within the gate channel and wherein the gate channel is configured to confine the second fluid between the inlet and the outlet of the gate channel.

11-12. (canceled)

13. The fluidic transistor of claim 0, wherein a cross-section of the flow channel and/or a cross-section of the gate channel varies in the direction of flow to create a contracting taper, an expanding taper, or another geometrical volume.

14. The fluidic transistor of claim 0, wherein the flow and gate channels are disposed in a single substrate or in different substrates, and optionally wherein the single substrate or the different substrates comprise glass, plastic, a semiconductor, a metal, an elastomer, or a combination thereof.

15-16. (canceled)

17. The fluidic transistor of claim 0, wherein the deformable region is configured to minimize fluidic communication between the flow and gate channels, or wherein the deformable region is configured to deflect upon applying pressure between the gate region and the source.

18. (canceled)

19. The fluidic transistor of claim 0, further comprising:
a deformable layer disposed between the flow channel and the gate channel, wherein the deformable region is disposed within the deformable layer.

20. The fluidic transistor of claim 0, further comprising a unity gain frequency of less than about 1 MHz, or wherein the fluidic transistor is characterized by a Shapiro number S that is greater than or equal to 1.

21-22. (canceled)

23. A fluidic network comprising one or more fluidic transistors of claim 1, other fluidic elements,
or a combination thereof.

24. The fluidic network of claim 0, wherein the fluidic transistor is configured in a common-source topology, common-gate topology, or a common-drain topology; or wherein the fluidic transistor is configured in a combination of two or more topologies, and wherein the topologies are selected from the group consisting of a common-source topology, a common-gate topology, and a common-drain topology.

25-27. (canceled)

28. The fluidic network of claim 0, wherein the fluidic network is configured as a fluidic amplifier, a fluidic flow-buffer, a fluidic regulator, a fluidic pressure-buffer, a fluidic level-shifter, or a fluidic logic gate;
optionally wherein the fluidic network further comprises a subcircuit, a fluidic load, a fluidic resistor, a fluidic capacitor, a fluidic inductor, a fluidic trap, and/or a fluidic filter.

29-41. (canceled)

42. A method of transforming an input fluidic signal within a fluidic network, the method comprising:
flowing a first fluid through a flow region adjacent to a deformable region configured to induce flow-limitation as the first fluid is transported; and
applying an input fluidic pressure signal to a second fluid located in a gate region adjacent to the deformable region,
wherein the flow-limitation experienced by the first fluid is controlled by the input fluidic pressure signal, and
wherein said applying the input fluidic pressure signal generates an output fluidic signal from the flow region of the first fluid.

43. The method of claim 0, wherein the output fluidic signal is controlled by the input fluidic pressure signal applied to the second fluid, the output fluidic signal is generated from the outlet of the flow region, or the output fluidic signal is generated from the inlet of the flow region.

44-46. (canceled)

47. A method of controlling flow within a fluidic network, the method comprising:
deforming a deformable region disposed between a flow region and a gate region of a fluidic transistor, thereby inducing flow-limitation of a first fluid being transported within the flow region.

48. The method of claim 0, wherein said deforming comprises:
applying a first pressure (P_{SD}) between a source and a drain, wherein each of the source and the drain is in fluidic communication with the flow region and wherein the first fluid is transported from the source to the drain; and
applying a second pressure (P_{GS}) between the gate region and the source,
wherein applying the first and second pressures can be performed in any order or simultaneously;
optionally wherein the first pressure (P_{SD}) is from about −100 to 1000 kPa; or
optionally wherein the second pressure (P_{GS}) is from about −100 to 1000 kPa.

49-62. (canceled)
